(19) United States
(12) Patent Application Publication
(10) Pub. No.: US 2025/0273077 A1
(43) Pub. Date: Aug. 28, 2025

(54) PROVIDING INTERACTIVE SERVICE TO SIMULATE OPERATIONS OF AN APPLICATION

(71) Applicant: Whatfix Private Limited, Bangalore (IN)

(72) Inventors: Charu Chhimpa, Bangalore (IN); Ayudh Das, Bangalore (IN); Vinay Rajpurohit, Bangalore (IN); Narayan Venkata Subramaniam, Bangalore (IN)

(21) Appl. No.: 18/647,974

(22) Filed: Apr. 26, 2024

(30) Foreign Application Priority Data
Feb. 23, 2024 (IN) 202441013070

(51) Int. Cl. G09B 5/02; G06F 40/143

(52) U.S. Cl. CPC G09B 5/02; G06F 40/143

(57) ABSTRACT

Some embodiments provide a novel method for providing simulated operations of a set of one or more applications with several display presentations through which several flows are defined. The method retrieves (1) non-flow-based content for two or more display presentations from a first storage structure, and (2) flow-based controls for the two or more display presentations from a second storage structure. Each particular flow-based control is associated with at least one particular display presentation and is selectable to direct the application set to transition to the particular display presentation. The non-flow-based content of each display presentation includes one or more sets of data for display in one or more sections of the display presentation. The method generates each of several simulated display presentations by combining the flow-based controls and non-flow-based content retrieved from the first and second storage structures.

### BACKGROUND

Current methods for creating and maintaining a training environment for an application include (1) creating a sandbox or training instance of the application, and (2) using image-based and Hypertext Markup Language (HTML)-based simulation tools. These existing solutions require much effort and are costly, and it can be difficult to upgrade and maintain the training environments. For instance, creating a sandbox or training instance of the application incurs an additional software license cost to install the application, and also does not typically have production-like data. Very high effort and cost are needed to create production-like data in these types of simulated environments. And, as the application changes, upgrading and maintaining these simulated environments is difficult.

Image-based simulation tools are popular among learning and development professionals to create simulation-based application training. However, several problems arise in maintaining these solutions. For example, if one display presentation in the application changes but its corresponding captured simulated display presentation is used in hundreds of simulation workflows, all of these simulation workflows need to be changed. This kind of change occurs often in practice, such as when a login page or home dashboard of the application changes or when the application is rebranded with new colors and styling. HTML-based simulation tools capture the HTML structure of each display presentation of an application and provide a slightly better response rendering compared to image-based simulation tools. However, these solutions also have a similar maintenance difficulty as the image-based simulation tools, as the approach is similar to the image-based simulation tools.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example simulation generator that creates a simulation of an application.

FIG. 2 illustrates an example set of display presentations that includes non-flow-based content and flow-based controls.

FIG. 3 illustrates an example workflow map that maps display presentations and links.

FIGS. 4A-B illustrate an example HTML code used to generate a page of an application and its corresponding snapshot.

FIG. 5 conceptually illustrates a process of some embodiments for collecting content of an application.

FIG. 6 illustrates an example simulation updater that automatically updates collected and stored content of display presentations used to generate simulated display presentations.

FIG. 7 illustrates a set of web servers that is accessed by a trained user to access an application and by a trainee to access a simulation of the application.

FIG. 8 illustrates a set of web servers that facilitates access of an application and an application training program.

FIG. 9 illustrates an example simulation pre-renderer that uses flow-based content and non-flow-based content to generate pre-rendered simulated display presentations.

FIG. 10 illustrates example display presentations and snapshots taken for the display presentations.

FIG. 11 illustrates an example data store that stores flow-based content for an application.

FIG. 12 illustrates an example simulation updater that facilitates non-flow-based content edits to a simulated application.

FIG. 13 illustrates an example simulation updater that facilitates flow-based content edits to a simulated application.

FIG. 14 illustrates an example edits storage structure.

FIG. 15 conceptually illustrates a process of some embodiments for updating information of an application to use for its corresponding simulated application.

FIG. 16 conceptually illustrates a process of some embodiments for collecting content of an application without access to the application's source code.

FIG. 17 conceptually illustrates a process of some embodiments for presenting a simulated application to a user.

FIG. 18 illustrates an example system that performs some embodiments of the invention.

FIG. 19 conceptually illustrates a process of some embodiments for creating and using a simulation of an application.

FIG. 20 illustrates an example SSR that creates a pre-computed DOM structure in JSON format.

FIG. 21 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for providing simulated operations of an application with several display presentations through which several flows are defined. The method retrieves (1) non-flow-based content for two or more display presentations from a first storage structure, and (2) flow-based controls for the two or more display presentations from a second storage structure. Each particular flow-based control is associated with at least one particular display presentation and is selectable to direct the application to transition to the particular display presentation. The non-flow-based content of each display presentation includes one or more sets of data for display in one or more sections of the display presentation. The method generates each of several simulated display presentations by combining the flow-based controls and non-flow-based content retrieved from the first and second storage structures.

The method is performed in some embodiments by a simulation generator that generates and maintains a simulation of the application. In some embodiments, the simulated operations are provided for purposes of training a user to use the application, and do not modify data stored in any data store used by the application to provide display presentations during non-simulation operation of the application. In such embodiments, the simulation generator does not affect the non-simulation operations of the application, and creates the simulated display presentations so that the user can learn how to use the application without actually accessing the application.

The simulated display presentations are in some embodiments pre-rendered before they are accessed by the user. In such embodiments, the simulated display presentations are ready for use by the user before they are needed for providing the simulated operations of the application. None of the simulated display presentations in such embodiments are rendered as they are presented to the user. In some of these embodiments, the simulated display presentations are generated after retrieving the non-flow-based content and flow-based controls respectively from the first and second storage structures.

In some embodiments, the simulation generator generates a set of one or more training display presentations to provide guided training for the user. These training display presentations are in some embodiments part of a digital adoption platform (DAP) that is used to visually guide the user through the simulated display presentations. For instance, the set of training display presentations in some embodiments includes a set of popup windows that is displayed along with the simulated display presentations. These popup windows guide the user through the flows in the simulated display presentations. The training display presentations can also be presented along with the display presentations of the actual application to provide guided training of the actual application.

The simulation generator conjunctively or alternatively generates other types of training content to display along with the simulated display presentations. Examples of such other content includes (1) contextual information about elements that need additional details, (2) additional pop windows (commonly referred to as beacons), (3) customizable selectable user interface (UI) items that trigger the presentation of a particular set of content (e.g., a particular video, link, popup window, etc.), and (4) any other suitable training content for an application.

The application in some embodiments includes a web application accessible through a browser. In such embodiments, the web application provides the display presentations through one or more display areas presented by the browser. When the web application is accessible through a browser, the simulation generator in some embodiments includes a module, program, or application that executes as a browser extension.

In some embodiments, the display presentations of the web application can be accessed to perform non-simulation operation of the web application using a first uniform resource locator (URL), and the simulated display presentations can be accessed to perform the simulated operations using a second URL. Different URLs are used to access the web application and the simulated display presentations, as the simulated display presentations simulate the operation of the web application without affecting the web application. In some of these embodiments, the second URL is similar to the first URL, but with at least one difference in order to differentiate it from the first URL.

The flow-based controls in some embodiments include at least one flow-based control that is part of at least two display presentations but is only stored once in the second storage structure. In such embodiments, this flow-based control is called a global flow-based control. Because each flow-based control is associated with the particular display presentation that is the “destination” of the flow-based control, the flow-based control does not have to be stored in the second storage structure each time it is identified in the display presentations.

In some embodiments, the simulation generator retrieves two or more code copies collected for the two or more display presentations. The code copies refer to the non-flow-based content (by specifying the non-flow-based content or by specifying identifiers (IDs) identifying the non-flow-based content) and may also specify IDs of the flow-based controls in some embodiments. These code copies are referred to as snapshots, in some embodiments, as they are point-in-time copies of code associated with the display presentations. In such embodiments, the simulated display presentations are generated by combining the code copies with the retrieved flow-based controls. Each code copy corresponds to a different display presentation and allows the simulation generator to generate each simulated display presentation with its flow-based controls and non-flow-based content. The code copies are in some embodiments Hypertext Markup Language (HTML) code copies (e.g., when the application is a web-based application).

As mentioned above, the code copies in some embodiments specify (1) an ID for each flow-based control and (2) the non-flow-based content. Each ID uniquely identifies a different flow-based control, and the IDs are specified in the second storage structure along with each flow-based control's associated display presentation(s). In some embodiments, at least two of the code copies specify a particular ID identifying a particular flow-based control such that the particular flow-based control is part of at least two simulated display presentations. In such embodiments, this particular flow-based control is part of multiple display presentations and is, therefore, part of multiple simulated display presentations.

The code copies in other embodiments specify (1) an ID for each flow-based control and (2) an ID for each of the non-flow-based content. In such embodiments, the non-flow-based content IDs are specified in the first storage structure along with the actual content (e.g., text, images, etc.) of the non-flow-based content. The code copies, when they specify the non-flow-based content, are stored in the first storage structure. The code copies, when they do not specify the non-flow-based content and instead specify IDs for the non-flow-based content, can be stored in the first storage structure or in a third storage structure.

In some embodiments, the non-flow-based content and the flow-based controls are custom defined for the application by one or more application developers of the application. In such embodiments, the application further includes a common set of content defined by a platform developer that developed a platform on which the application operates. The platform includes at least one of an operating system or a browser on which the application operates. The common set of content is part of the operating system or browser and does not have to be part of the set of simulated display presentations, as the common set of content does not contribute to the operations of the application.

The simulation generator in some embodiments presents the set of simulated display presentations to a user in a set of one or more display areas of a user interface (UI), such as a graphical user interface (GUI). In some of these embodiments, the simulated display presentations are presented successively such that one simulated display presentation is presented at a time. In such embodiments, when the user selects a flow-based control in a first simulated display presentation that is currently displayed in the UI, the simulation generator will replace the first simulated display presentation in the UI with a second simulated display presentation that is associated with the selected flow-based control.

Conjunctively or alternatively, at least two simulated display presentations are presented concurrently to the user. In such embodiments, upon selection of a flow-based control in a first simulated display presentation currently presented in the UI, the simulation generator will present a second simulated display presentation in the UI along with the first simulated display presentation. In some of these embodiments, the first and second simulated display presentations are displayed in different display areas of the UI. In other embodiments, the first and second simulated display presentations are displayed in a same display area of the UI.

In some embodiments, each of the flows includes a different sequence of one or more flow-based controls that defines a different order of at least a subset of display presentations. Each sequence of flow-based controls can be followed to step through the associated subset of display presentations. As such, each flow can be stepped through using the flow-based controls included in the simulated display presentations.

The simulated display presentations in some embodiments provide the simulated operations for one or more applications. In such embodiments, the simulation generator uses non-flow-based content and flow-based controls for display presentations of each application to present to a user. The user is then able to interact with the simulated display presentations (e.g., by selecting flow-based controls) in one or more display areas of a UI to train to use each application. In some embodiments, the user selects a flow-based control in a first simulated display presentation that simulates a first display presentation for a first application. Upon selection of the flow-based control, the simulation generator transitions to presenting a second simulated display presentation that simulates a second display presentation for a second application. Conjunctively or alternatively, a user can select a flow-based control that transitions from one simulated display presentation to another that both simulate display presentations of a same application.

The application is in some embodiments a single standalone application. In such embodiments, the simulation generator provides simulated operations of the single standalone application. The single standalone application can be a single web-based application. This web-based application can be implemented by a cluster of one or more application servers accessible through a cluster of one or more web servers. In such embodiments, the web server cluster facilitates access to the application server cluster and the web-based application. The application server cluster can execute on one or more virtual machines, Pods, or standalone server computers in a datacenter (e.g., private datacenter, public datacenter). The cluster of web servers can also execute on one or more virtual machines, Pods, or standalone server computers in a public or private datacenter.

In some embodiments, the retrieving and generating are performed by the simulation generator to provide simulated operations of a set of two or more applications. In such embodiments, the simulation generator generates simulated display presentations to train a user to use two or more applications, e.g., when flows span multiple applications (as flow-based controls in one application can start a user's interactions with another application). The simulation generator in such embodiments generates one simulation for the set of applications. Each application in the application set can have (1) a different service performed by the application, (2) a different source code for the application, (3) a different application developer that developed the application, and/or (4) a different cluster of one or more application servers that executes the application. Examples of services performed by an application include customer support, banking, communications (e.g., email), stock exchange, streaming, rideshare, food delivery, etc. One application can perform a set of one or more services.

The application set in some embodiments includes two or more web-based applications that are implemented by two or more different clusters of two or more application servers. In such embodiments, the web-based applications can be accessed through a same set of one or more web servers or through different sets of one or more web servers.

Some embodiments provide a novel method for collecting data to use to simulate operations of an application with several output display presentations through which several flows are defined. The method identifies different sets of non-flow-based content that describe different output display presentations provided by the application. The method identifies a set of flow-based controls each of which defining a transition to an output display presentation from another output display presentation. The method stores the sets of non-flow-based content in a first storage structure and the set of flow-based controls in a second storage structure to use to generate simulated display presentations to provide simulated operations of the application.

In some embodiments, the different sets of non-flow-based content include at least one of (1) different sets of code that describe the different output display presentations provided by the application and (2) different images that are part of the different output display presentations provided by the application. The different sets of code, when processed, produce the different output display presentations that are to be displayed in a UI to present the application. For example, these different sets of code are defined as a markup language code (e.g., HTML code) that is used to define each output display presentation and its visual components.

A simulation generator in some embodiments identifies the different sets of non-flow-based content by examining, in a UI that is presenting the application, each particular output display presentation to identify a particular set of non-flow-based content included in the output display presentation. In such embodiments, the simulation generator is notified, from an administrator of the application, that a recording of the application in the UI has been initiated. This recording allows the simulation generator to view the administrator's interaction with the application in the UI to identify the non-flow-based content in each output display presentation.

In some embodiments, the different sets of non-flow-based content include different sets of HTML code. In such embodiments, while examining the application in the UI, the simulation generator identifies the different HTML code sets used for the output display presentations. The sets of non-flow-based content may conjunctively or alternatively include sets of code in any other markup language or a custom-defined language.

The simulation generator in some embodiments identifies the flow-based controls by detecting, in the UI, selections of different selectable elements of the application that cause different output display presentations to be displayed in the UI. In such embodiments, each flow-based control is represented in each output display presentation by a different selectable element. When a selectable element is selected in the UI, the simulation generator detects that the associated flow-based control is being selected. Selection of a selectable element can include detecting a cursor selection (e.g., a single or double cursor click) of the selectable element or any other suitable selection of a UI element.

After detecting a selection of a selectable element, the simulation generator in some embodiments associates the selectable element to its respective output display presentation that is displayed upon selection of that selectable element. This association defines the flow-based control. In such embodiments, each flow-based control is defined using a selectable element as its source and an output display presentation as its destination. This output display presentation is the output display presentation to which the application transitions, and not the initial (i.e., source) output display presentation that displays the source selectable element. By not defining a flow-based control based on its source output display presentation, the simulation generator is able to identify the same flow-based control in other output display presentations, as long as the source selectable element and destination output display presentation are the same.

For example, the simulation generator in some embodiments examines a first output display presentation displayed in the UI. During this examination, the simulation generator collects a first set of non-flow-based content for the first output display presentation. Upon detection of a selection of a selectable element that causes a second output display presentation to be displayed in the UI, the simulation generator collects this flow-based control by associating the selected selectable element to the second output display presentation. Then, the simulation generator examines the second output display presentation to collect a second set of non-flow-based content for the second output display presentation.

In some embodiments, each flow-based control stored in the second storage structure specifies a first ID identifying the flow-based control, a second ID identifying a selectable element as a source of the flow-based control, and a third ID identifying an output display presentation as a destination of the flow-based control. In such embodiments, this information is all that is needed to define each flow-based control, as this allows the simulation generator to know which output display presentation is to be displayed upon selection of each selectable element of the application. Each flow-based control is defined using only a destination output display presentation of the flow-based control and not a source output display presentation of the flow-based control in some embodiments, as the source selectable element is defined as its source instead.

In some of these embodiments, each flow-based control stored in the second storage structure further specifies whether the flow-based control is a local flow-based control or a global flow-based control. Each local flow-based control is applied on only one output display presentation. For example, an administrator in some embodiments specifies, to the simulation generator, that a particular flow-based control is a local flow-based control. The administrator may also specify on which output display presentation it is located. As such, the simulation generator will not apply this flow-based control to any other output display presentations, even if the same selectable element is identified in other output display presentations. These selectable elements would be treated as different selectable elements, regardless of whether they have the same appearance as the source selectable element of the local flow-based control. In some of these embodiments, the simulation generator does include the source display presentation of each local flow-based control in the second storage structure.

Each global flow-based control is applied on each output display presentation that includes the selectable element of the global flow-based control. For example, an administrator in some embodiments specifies, to the simulation generator, that a particular flow-based control is a global flow-based control. As such, each time the selectable element associated with the global flow-based control is identified in an output display presentation, the simulation generator knows that it is the particular flow-based control. The simulation generator in some embodiments does not receive notification from the administrator regarding which flow-based controls are local or global. In such embodiments, the simulation generator treats each flow-based control as a global flow-based control. In embodiments where the simulation generator does not receive notification from the administrator regarding which flow-based controls are local or global, the simulation generator identifies each flow-based control as a local flow-based control upon its first identification in one of the application's output display presentations, and updates its type to a global flow-based control if it is identified a second time in another output display presentation.

In some embodiments, rather than examining the application in a UI, the simulation generator identifies the set of flow-based controls and sets of non-flow-based content from a set of code associated with the application. In such embodiments, the set of code associated with the application is a source code of the application. This source code defines everything regarding the application, including the flow-based controls and non-flow-based content of the output display presentations.

The simulation generator in some embodiments requests the source code from an application server that implements the application. This application server implements the application and stores the source code needed to implement the application. Alternatively, the simulation generator in some embodiments retrieves the source code from a data storage storing the source code. In such embodiments, the simulation generator has access to this data storage and is authorized to access the source code without requesting it from the application server.

Rather than examining the application in a UI or examining the entire source code of the application, the simulation generator in some embodiments sends, to the application server that implements the application, a set of one or more Application Programming Interface (API) requests requesting the set of code associated with the application. In such embodiments, the simulation generator receives, from the application server, a set of one or more API responses that includes the set of code. This set of code in such embodiments may be the entire source code or only a portion of it. The simulation generator may only receive a portion of the source code if the application server determines that, based on the API requests, the simulation generator only needs this portion.

Each flow-based control is in some embodiments stored only once in the second storage structure. This is done in some embodiments to save space in the second storage structure, and because only one entry is needed (as the source output display presentations for global flow-based controls are not specified, and as local flow-based controls are only identified from the application once). In such embodiments, if a flow-based control is identified more than once, it is only stored upon its first identification by the simulation generator.

Some embodiments provide a novel method for providing simulated operations of an application with several display presentations through which several flows are defined. The method collects, and stores in a data store, several display presentations produced by the application for display in several different display areas. The method iteratively re-collects the display presentations to analyze to identify any display presentation that has been modified since the display presentation's last collection. For any particular display presentation that is identified as having been modified since the last collection, the method modifies the particular display presentation in the data store to reflect any modification to the particular display presentation since the last collection. The method uses the display presentations stored in the data store to provide the simulated operations of the application.

In some embodiments, a simulation generator modifies the particular display presentation in the data store by modifying a portion of data of the display presentation stored in the data store without modifying any other data that has not been modified since the last collection. In such embodiments, the simulation generator only modifies the portion that has been changed since the last collection, and leaves the content that has not been modified.

In other embodiments, the simulation generator modifies the particular display presentation in the data store by replacing the particular display presentation stored at the last collection with an updated version of the particular display presentation that represents any modifications made since the last collection. In such embodiments, the simulation generator deletes the particular display presentation stored since at the last collection and stores the updated version.

The simulation generator in some embodiments collects and stores the display presentations by collecting and storing non-flow-based content and flow-based controls included in the display presentations of the application. In such embodiments, each particular flow-based control is associated with at least one particular display presentation and is selectable to direct the application to transition to the particular display presentation. By selecting different flow-based controls, a user can step through different flows of the application.

The non-flow-based content of each display presentation includes one or more sets of data for display in the different display areas. This data is not selectable in the display areas (unlike the flow-based controls), and can include any text, images, or any other non-selectable content of the application.

In some embodiments, the simulation generator modifies the particular display presentation in the data store by modifying a set of non-flow-based content of the particular display presentation. In such embodiments, the simulation generator updates non-flow-based content that has changed in the application since the last collection by updating the data stored for it. Conjunctively or alternatively, the simulation generator modifies the particular display presentation in the data store by modifying a flow-based control of the particular display presentation. In such embodiments, the simulation generator can update the source (i.e., the source selectable element) of the flow-based control, the destination (i.e., the destination display presentation), and/or the appearance (e.g., font, color, location, size, etc.) of the source of the flow-based control. Any suitable change to non-flow-based content or a flow-based control can be identified by the simulation generator and updated in the data store.

In some embodiments, the data store includes a first storage structure for storing the non-flow-based content and a second storage structure for storing the flow-based controls. In such embodiments, the non-flow-based content and flow-based controls are stored separately, as they are not linked to each other. For example, non-flow-based content does not specify any flow-based controls, and no flow-based controls include any non-flow-based content. While they are separately collected, however, some embodiments store both the non-flow-based content and the flow-based controls in a single data store.

The simulation generator in some embodiments iteratively re-collects the display presentations to analyze by comparing the display presentations collected and stored at the last collection to the re-collected display presentations to identify any modifications that have been made to any display presentation since the last collection. By comparing the previously collected and stored display presentations to newly collected display presentations, the simulation generator can identify any changes that have been made to the application since the last collection.

In some embodiments, the simulation generator compares the display presentations collected and stored at the last collection to the re-collected display presentations by comparing a first set of code copies for the display presentations collected and stored at the last collection to a second set of code copies of the re-collected display presentations. In such embodiments, the simulation generator collects display presentations by copying a code for each display presentation. These code copies can then be used to compare previously collected display presentations with newly collected display presentations. The first and second code copies are in some embodiments first and second HTML code copies, however, they can in be described using any other markup language or custom-defined language.

Conjunctively or alternatively, the simulation generator in some embodiments generates a hash of each re-collected display presentation and its respective display prestation collected and stored at the last collected to identify any modifications that have been made to any display presentations since the last collection. In such embodiments, the hash calculation identifies differences between the re-collected display presentations and the stored display presentations. Any identified differences are the modifications that have been made to the display presentations since the last collection.

The re-collecting is performed iteratively in some embodiments as part of an automated process that identifies modifications made to the display presentations. In such embodiments, the automated process does not require direct user input regarding the modifications to the display presentations. More specifically, the administrator of the application does not have to manually notify the simulation generator of any modifications made to the application (i.e., to any display presentations of the application).

In some embodiments, the simulation generator uses the display presentations stored in the data store to provide the simulated operations of the application by generating simulated display presentations to simulate the application. These simulated display presentations, when interacted with in a UI (e.g., a GUI) by a user, will simulate the operations of the application. The user can then use the simulated display presentations to learn how to use the application without actually accessing the application.

The simulation generator in some embodiments also receives a direction from an administrator of the application to edit a first set of content in a first simulated display presentation to a second set of content. In such embodiments, while the collected display presentation and the display presentation associated with the first simulated display presentation will continue to include the first set of content, the first simulated display presentation will be edited. The administrator may do this in some embodiments to edit or redact some content (e.g., personally identifiable information (PII) data), that is included in the actual application, from the simulation. As such, the simulation generator edits the first set of content in the first simulated display presentation to the second set of content.

In some embodiments, the simulation generator also stores a particular entry in a data structure identifying a set of one or more edits to be made to the simulated display presentations. The particular entry specifies that the first set of content is to be edited to the second set of content in at least the first simulated display presentation. The particular entry in some embodiments specifies the first set of content as the original content and the second set of content as the replacement content. The particular entry may also specify an edit ID uniquely identifying the edit, and/or a simulated display presentation ID identifying the first simulated display presentation.

The data structure storing the set of edits is in some embodiments separate from the data store storing the display presentations. As such, the set of edits is applied only to the simulated display presentations and not to the display presentations stored in the data store.

The direction from the administrator in some embodiments indicates that the edit is a local edit. When the edit is a local edit, the first set of content is to be edited to the second set of content only in the first simulated display presentation (which is specified by the administrator's direction) and not any other simulated display presentations that also include the first set of content. In such embodiments, if the simulation generator identifies that the first set of content is also included in any other simulated display presentations, the simulation generator will not edit it to the second set of content.

In other embodiments, the direction of the administrator indicates that the edit is a global edit. When the edit is a global edit, the first set of content is to be edited to the second set of content in all simulated display presentations, including the first simulated display presentation, that include the first set of content. In such embodiments, the simulation generator examines the simulated display presentations, identifies any simulated display presentations other than the first simulated display presentation that include the first set of content, and edits the first set of content to the second set of content in each of the identified simulated display presentations. While a global edit can be used to edit multiple simulated display presentations, it only has one entry in the data structure in some embodiments.

In some embodiments, the first simulated display presentation is generated to simulate the particular display presentation and was edited to change the first set of content to the second set of content before the particular display presentation was modified in the data store. In such embodiments, after modifying the particular display presentation in the data store, the simulation generator uses the modified particular display presentation to generate a second simulated display presentation to replace the first simulated display presentation. This second simulated display presentation reflects the modifications made to the particular display presentation. Then, the simulation generator compares the set of edits stored in the data structure to the second simulated display presentation to determine whether any edits need to be made to the second simulated display presentation. As each simulated display presentation is generated, the simulation generator compares the set of edits in the data structure to the simulated display presentation to ensure that each edit is properly applied to all of the simulated display presentations generated for the application.

The simulation generator identifies the first set of content in the second simulated display presentation. Then, after matching the first set of content in the second simulated display presentation to the particular entry stored in the data structure, the simulation generator edits the first set of content to the second set of content in the second simulated display presentation. Now, the second simulated display presentation reflects the modified particular display presentation and includes the edit received from the application administrator.

Before describing the below figures, several terms are defined. A display area is defined as a region (e.g., a display window) in a UI (e.g., in a GUI) that can present content of an application. A display presentation (also referred to below as an output display presentation or a screen) is defined as visual content of an application that is displayed in a display area of the UI. An application typically has multiple display presentations that present multiple different sets of content. The sets of content of different display presentations can be overlapping (e.g., when two display presentations have at least some content in common).

A web application (also called a web-based application) in some embodiments is an application that is accessible through a web server. A web application can provide its output as multiple web pages. In some embodiments, each web page of a web application can include one or more display presentations. For example, a web page that includes one or more popup windows and/or dropdown menus has multiple associated display presentations, as each popup window and each dropdown menu will result in a new display presentation.

A simulated display presentation is defined as a display presentation that is presented during a simulated operation of the application. A simulated display presentation is generated for each display presentation of the application to simulate the operations of the application. To a user viewing the simulated display presentations, they appear identical in some embodiments to the display presentations of the application that would be presented during normal (i.e., non-simulation) operation of the application.

A selectable element is a UI item in a display presentation that a user can select (e.g., through a cursor click or double-click operation). In some embodiments, a selectable element is associated with a set of one or more attributes, such as an element ID that uniquely identifies the element, any inner text or icons specified in the element, a class of the element, and the appearance of the element (e.g., location, font, color, shape, etc.).

A flow-based control (also referred to as a flow control or a link) is a UI control that connects (e.g., links) one display presentation (or simulated display presentation) to another display presentation. When a flow-based control in a first display presentation connects the first display presentation to a second display presentation, a user's selection of the flow-based control typically causes the application to present the second display presentation. The flow-based controls of an application allow a user to sequentially traverse through the display presentations (e.g., as part of a workflow as described below). The flow-based controls in some embodiments are also referred to as navigation controls, as they allow a user to navigate from one display presentation to another display presentation (e.g., by using one or more cursor control operations (such as a click double click, etc.), one or more keyboard inputs, and/or one or more other UI operations). As commonly understood, a cursor is a positional input element that identifies a position in a GUI and can be moved by using a cursor controller, such as a mouse, trackpad, etc.

Non-flow-based content is defined as content (e.g., text strings, images, video, audio, etc.) of a display presentation or a simulated display presentation that is not associated with flow-based content (e.g., a flow-based control or an element). Non-flow-based content only provides visual content to a display presentation or simulated display presentation. It is not selectable in a UI.

A workflow (also referred to as a flow, in some embodiments) is defined as a sequence of one or more flow-based controls through which a user of the application or the simulated application can step. A workflow can also be defined as a sequence of steps taken on a single display presentation or simulated display presentation, such that the workflow does not include any flow-based controls to another display presentation or simulated display presentation.

A DAP is defined as a software layer executing on top of an application to provide guided in-application assistance to users. It is a Software as a Service (SaaS) program that can be used along with an application or a simulated application to provided guided training of the application or simulated application.

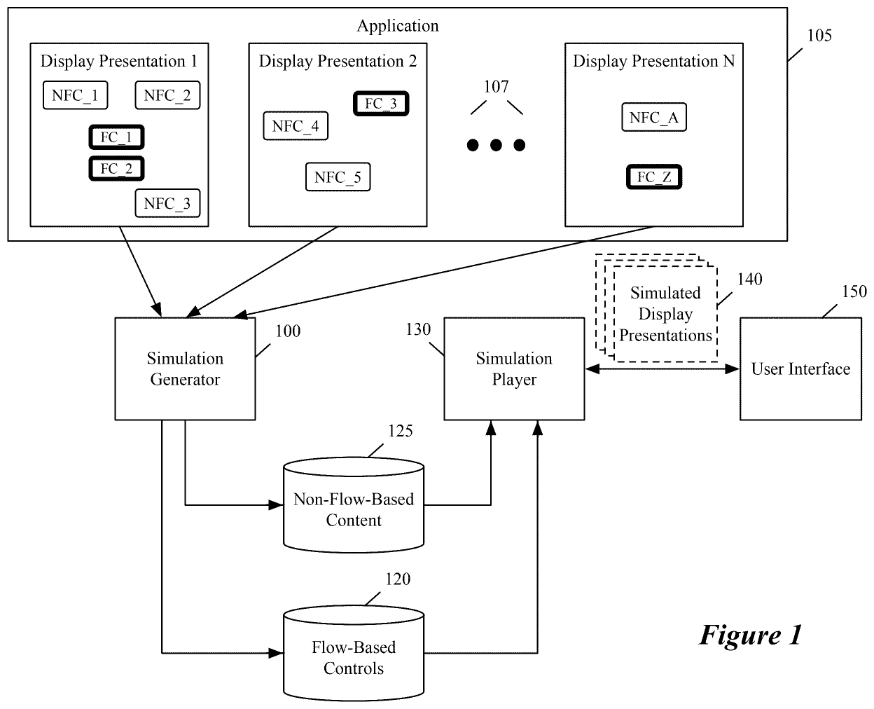

In several examples described below by reference to FIGS. 1-21, the simulated application is a web application. However, one of ordinary skill will realize that some embodiments of the invention are used to simulate the operation of non-web-based applications, such as desktop applications and mobile applications that use HTML, Cascading Style sheets (CSS), or JavaScript (JS).

Also, in several examples described below, the simulated operations relate to the operations of one application. However, as mentioned above, some embodiments are used to provide simulations that train a user to operate multiple applications. For instance, some embodiments generate simulated display presentations for multiple applications when the display presentations of one or more applications have links or commands that can imitate or otherwise refer to operations of one or more other applications. At least one of the simulated display presentations can be created based on a display presentation of a first application, while also including a flow-based control that transitions to a simulated display presentation created based on a display presentation of a second application. Each simulated display presentation can include (1) one or more flow-based controls that transition to one or more other simulated display presentations of the same application and/or (2) one or more flow-based controls that transition to one or more other simulated display presentations of one or more other applications.

FIG. 1 illustrates an example simulation generator 100 that creates a simulated application of an application 105. In this example, the application 105 includes a set of one or more display presentations 107, and each display presentation includes at least one of flow-based controls and non-flow-based content. As shown, the non-flow-based content is illustrated using thin lines, and the flow-based controls are illustrated using thick lines. For example, display presentation 1 includes flow-based controls 1 and 2, and non-flow-based content 1-3. Display presentation 2 includes flow-based control 3, and non-flow-based content 4 and 5. Display presentation N includes flow-based control Z, and non-flow-based content A.

In some embodiments, the application 105 is a web-based application, such as an application that is accessible through one or more web servers. Accordingly, each display presentation 107 of the application 105 is part of one or more output web pages (e.g., rendered web pages) of the web-based application. In some embodiments, one web page can include one or more display presentations of the application 105. For example, a first web page in some embodiments has only one display presentation (e.g., display presentation 1), while a second web page has two or more display presentations (e.g., at least display presentation 2 and N). Each web page and each output display presentation 107 of the web-based application can be described using any markup language, such as HTML.

Each flow-based control included in the display presentations 107 is associated with at least one particular display presentation and is selectable to direct the application 105 to transition to the particular display presentation. The non-flow-based content included in the display presentations 107 includes one or more sets of data for display in one or more sections of the display presentations 107. In some embodiments, the non-flow-based content and flow-based controls of the application 105 are custom defined for the application 105 by one or more application developers of the application 105. In such embodiments, the application 105 further includes a common set of content (not shown) defined by a platform developer that developed a platform on which the application 105 operates. The platform includes at least one of an operating system or a browser on which the application 105 operates. The common set of content is part of the operating system or browser and does not have to be part of the simulated display presentations 140 (which will be described below), as the common set of content does not contribute to the operations of the application 105.

The simulation generator 100 copies all of the flow-based controls in each display presentation 107 and stores it in a flow-based control data store 120. The simulation generator 100 also copies the non-flow-based content in each display presentation 107 and stores it in a non-flow-based content data store 125. In some of these embodiments, the simulation generator 100 takes a snapshot (e.g., an HTML snapshot) of each display presentation 107 to collect the non-flow-based content. A snapshot is a point-in-time copy of a display presentation (e.g., of the code that, when processed, produces the display presentation). Further information regarding snapshots will be described below.

Once the flow-based controls and non-flow-based content are stored in their respective data stores 120 and 125, a simulation player 130 uses this information to generate and present a set of one or more simulated display presentations 140 to a user through a user interface 150. The simulation player 130 retrieves the non-flow-based content for the display presentations 107 from the data store 125, and the flow-based controls from the data store 120. The user interface 150 is in some embodiments a GUI.

Rather than the simulation player 130 generating the simulated display presentations 140, the simulation generator 100 in other embodiments generates the simulated display presentations 140. In such embodiments, the simulation generator 100 uses the flow-based controls and the non-flow-based content from the data stores 120 and 125 to generate the simulated display presentations. Still, in other embodiments, a simulation pre-renderer (not shown) generates the simulated display presentations 140. Further information regarding a simulation pre-renderer will be described below.

The simulated display presentations 140 are presented to the user as a simulated application of the application 105 for purposes of training the user to use the application 105. The user's interaction with the simulated display presentations 140 does not modify any data stored in any data store (not shown) used by the application 105 to provide the display presentations 107 during non-simulation operation of the application 105.

In some embodiments, the application 105 is a web application accessible through a browser such that the display presentations 107 are provided through one or more display areas presented by the browser. In some of these embodiments, the simulated display presentations 140 are also accessible through a browser. The display presentations 107 and simulated display presentations 140 are in such embodiments accessible using different URLs.

The simulated display presentations 140 allow the user to learn how to use the application 105 without actually using or accessing the application 105. For example, the application 105 is in some embodiments a customer support application, and the user interacts with the simulated display presentations 140 to learn how to use the customer support application without affecting anything in the actual application 105. In some embodiments, the simulated display presentations 140 are presented successively such that one simulated display presentation is presented at a time. In such embodiments, when the user selects a flow-based control in a first simulated display presentation that is currently displayed in the UI 150, the simulation player 130 will replace the first simulated display presentation in the UI 150 with a second simulated display presentation that is associated with the selected flow-based control.

Conjunctively or alternatively, at least two of the simulated display presentations 140 are presented concurrently to the user. In such embodiments, upon selection of a flow-based control in a first simulated display presentation currently presented in the UI 150, the simulation player 130 will present a second simulated display presentation in the UI 150 along with the first simulated display presentation. The first and second simulated display presentations can be displayed in different display areas of the UI 150 or in a same display area of the UI 150.

Simulated applications are commonly used in training users to use actual applications, and because the simulation generator 100 collects and stores the flow-based controls and non-flow-based content separately, the simulated display presentations 140 are more easily and efficiently modified in the event that the application 105 is updated.

For example, non-flow-based content displayed in one or more of the display presentations 107 in some embodiments is modified. However, because the flow-based controls and non-flow-based content are collected and stored separately, the simulation generator 100 only has to re-collect the modified non-flow-based content. None of the flow-based controls have to be re-collected, decreasing maintenance effort of the simulation generator 100.

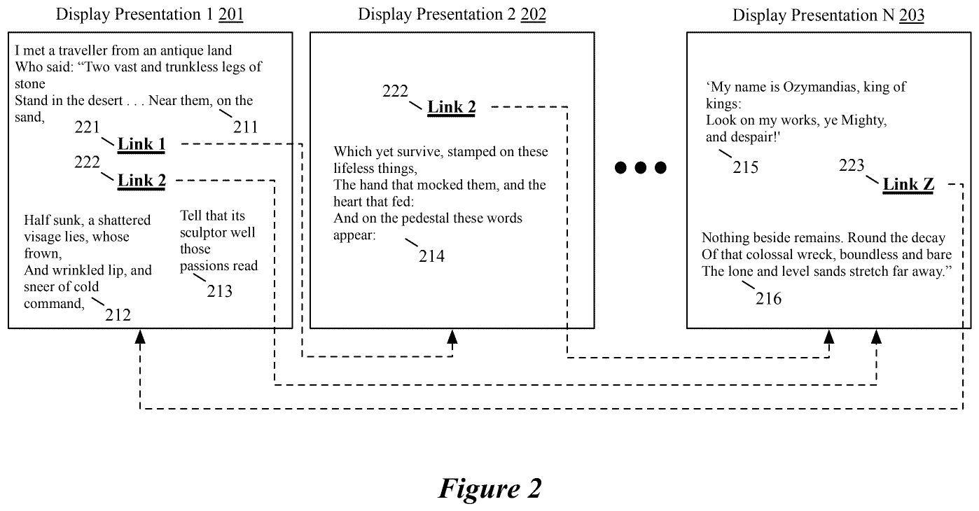

FIG. 2 illustrates a set of display presentations 201-203 that more specifically shows examples of flow-based controls and non-flow-based content. In this figure, the first display presentation 201 specifies non-flow-based content 211-213 and flow-based controls 221-222. The second display presentation 202 specifies non-flow-based content 214 and flow-based control 222 (as does display presentation 201). The third display presentation 203 displays non-flow-based content 215-216 and flow-based control 223. Each of the display presentations 201-203 can specify any amount of non-flow-based content and any number of flow-based controls.

In this figure, the non-flow-based content 211-216 includes strings of text that are shown in the display presentations 201-203. It is referred to as non-flow-based content because interaction with the text strings 211-216 (e.g., cursor control operations) when displayed in a user interface (such as a GUI) does not cause a change from one display presentation to another. Non-flow-based content can conjunctively or alternatively include any other type of multi-media, such as images, videos, or audio.

The flow-based controls 221-223 in this figure are different links that, when interacted with in a user interface (e.g., cursor control operations), cause the user interface to display a corresponding “target” (or “destination”) display presentation. For example, when the first display presentation 201 is displayed in a user interface and a user selects the first link 221, the user interface will display the second display presentation 202 (as denoted by the dashed arrow). When the first display presentation 201 is displayed in a user interface and a user selects the second link 222, the user interface will display the third display presentation 203.

Similarly, when the second display presentation 202 is displayed in a user interface and a user selects the second link 222, the user interface will display the third display presentation 203. While the second link 222 is included in different “source” display presentations 201 and 202, it is considered to be the same link because the target display presentation 203 is the same. This link 222 is referred to as a global link in some embodiments, as opposed to a local link which is only included in one display presentation. Global and local links are each in some embodiments stored once in a data structure. Further information regarding links will be described below.

As shown, the links 221-223 presented in the display presentations 201-203 are displayed in order for users viewing the display presentations 201-203 to switch between which display presentation is being currently presented to them. In some embodiments, only one display presentation is shown to a user at a time. In other embodiments, at least two display presentations can be presented at once.

The links 221-223 can be presented in the display presentations 201-203 as flow-based controls (e.g., selectable UI items, which can be referred to as elements). These flow-based controls are actual selectable elements in the application that includes the display presentations 201-203. When creating a simulation for the application, some embodiments collect the non-flow-based content 211-216 and store it, and separately collect and store flow-controls for the links 221-223.

Because the stored link information for each link does not specify the source display presentation, the non-flow-based content and links are considered decoupled in the data stores. This is because non-flow-based content and flow-based controls can be separately re-collected and updated in the data stores, without having to re-collect and store the other content. For example, when the non-flow-based content 211 in the first display presentation 201 is modified, neither of the links 221-222 have to be re-collected, as the link information stored for these links 221-223 does not specify the source display presentation of these links. Moreover, the other non-flow-based content 212-213 in the first display presentation does not have to be re-collected, as it was not modified and is stored as separate entries in a data store from an entry corresponding to the non-flow-based content 211.

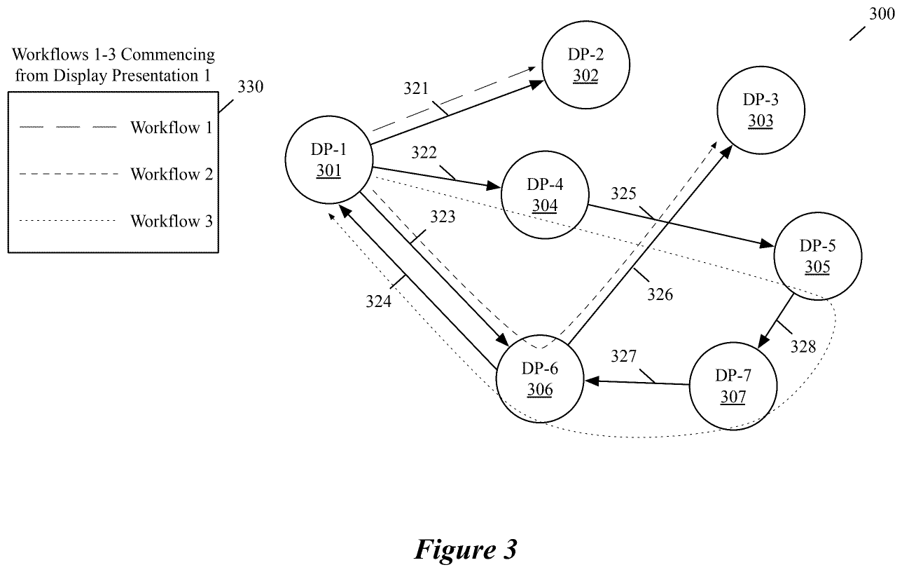

When flow-based controls are collected for an application, workflows for the application are in some embodiments also collected. A workflow is a sequence of one or more flow-based controls that a user of the application or the simulated application can step through. FIG. 3 illustrates an example workflow map 300 that maps display presentations 301-307 and their links 321-328. In this example, there are seven display presentations 301-307 and eight links 321-328, however a workflow map can include any number of display presentations and any number of links (which depends on the application from which the workflow map was generated).

As shown, display presentation 301 is associated with a first outgoing link 321 to display presentation 302, a second outgoing link 322 to display presentation 304, and a third outgoing link 323 to display presentation 306. This means that display presentation 301 includes flow-based controls that lead to these display presentations 302, 304, and 306. Display presentations 302 and 303 are not associated with any outgoing links, meaning that these display presentations 302 and 303 do not include any flow-based controls that lead to other display presentations.

Display presentation 304 is associated with one outgoing link 325 to display presentation 305, and display presentation 305 is associated with one outgoing link 328 to display presentation 307. Display presentation 306 is associated with a first outgoing link 324 to display presentation 301 and a second outgoing link 326 to display presentation 303, and display presentation 307 is associated with one outgoing link 327 to display presentation 306.

This map 300 also illustrates different workflows. As defined by the legend 330, a first workflow is denoted using a long-dashed line, a second workflow is denoted using a medium-dashed line, and a third workflow is denoted using a short-dashed line. Workflow 1 starts at display presentation 301 and ends at display presentation 302 (i.e., workflow 1 includes only link 321). Workflow 2 starts at display presentation 1, goes through display presentation 306, and ends at display presentation 303 (i.e., workflow 2 includes links 323 and 326). Workflow 3 starts at display presentation 301, goes through display presentations 304, 305, 307, and 306, and ends back at display presentation 301 (i.e., workflow 3 includes links 322, 325, 328, 327, and 324). While only three workflows are illustrated in this figure for brevity, the workflow map 300 also includes other workflows such as a workflow from display presentation 304 to display presentation 305. Any sequence through any of the links 321-327 can be considered a workflow.

In some embodiments, a workflow does not include any links and takes place on only one display presentation. For example, a particular workflow defined by the administrator in some embodiments includes the user finding a particular flow-based control or a particular set of non-flow-based content in a particular display presentation, but the user is not required to select anything. This workflow includes one display presentation and does not include any links to any other display presentations. As another example, a workflow with no links in some embodiments is defined for a user to identify a set of content (e.g., non-flow-based content and/or flow-based controls) in a particular display presentation representing a home page of the application. The workflow is defined in such embodiments for the user to learn about all of the content of the display presentation representing the home page, without transitioning to any other display presentations of the application.

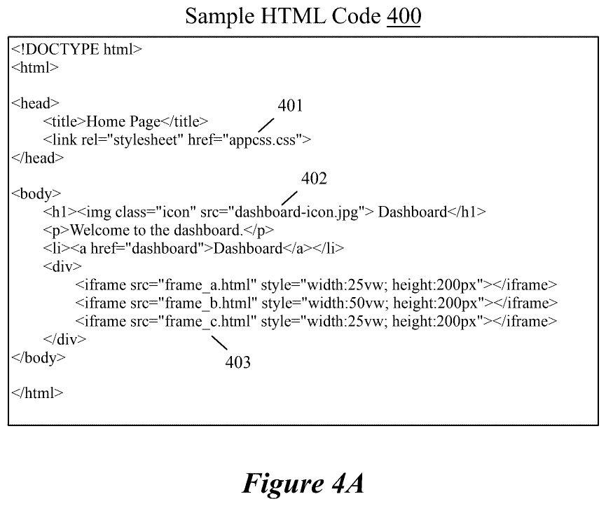

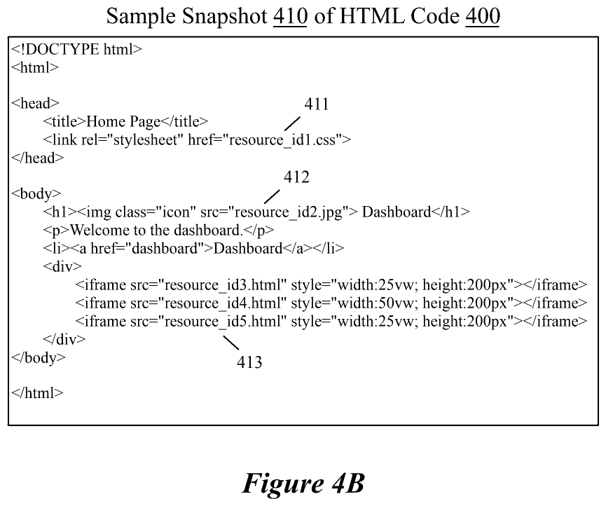

Non-flow-based content and flow-based controls of one or more display presentations are in some embodiments defined in a set of code (e.g., an HTML code). This set of code, when processed, produces one or more pages of an application from which the display presentations are defined. FIGS. 4A-B illustrate an example HTML code 400 defined for a page of an application and its corresponding snapshot 410 taken. In this example, the code 400 is defined and processed (e.g., executed) to compute or render the page, and the snapshot 410 is taken to compute or render a simulated version of the page.

From this one page, one or more display presentations of the application can be defined. For example, the initial page rendered from the code 400 is in some embodiments defined as a first display presentation, and any visual changes to the page (e.g., a popup window, a dropdown menu, etc.) define other display presentations from the same page.

FIG. 4A illustrates the code 400, which includes various elements, tags, and attributes that define the content and links of the display presentation. For example, the <head> tag defines the title to be generated for the display presentation, and the <body> tag defines the heading and paragraph to be generated for the display presentation. The <li> tag adds a list item.

The <div> tag includes a set of iframes for creating iframes in the page. This example shows three iframes that respectively occupy 25%, 50%, and 25% of the overall width of the window, with 200px (pixel) height. Each of these frames will be included in the display presentation according to their allotted percentage of space in the display presentation. The code 400 can also specify the content (e.g., non-flow-based content, flow-based controls) of each frame. While this example includes multiple frames to be included in this single page, a set of code for a page can define any number of frames for the page.

FIG. 4B illustrates the snapshot 410 that can be taken of the HTML code 400. The snapshot 410 is loaded in a browser using a different URL than the URL that renders the HTML code 400. In some embodiments, the URL for the snapshot 410 includes a unique ID that identifies the actual application (i.e., the application that has the HTML code 400), such as a universally unique identifier (UUID).

Most of the code of the snapshot 410 is the same as the HTML code 400. However, there are some differences. For example, “app.css” mentioned in the HTML code at 401 is downloaded and uploaded to a simulation updater and served from the unique URL “resource_id1.css” specified in the snapshot at 411. This resource_id1 in some embodiments is a UUID, but can be any unique identifier.

The dashboard image 402 specified in the HTML code is copied in the snapshot 410, which reference by a second resource ID 412. While this snapshot image associated with the second resource ID 412 is a copy of the HTML code's image 402, it is stored separately and served directly from the application simulator. The iframe IDs 403 (i.e., frame_a, frame_b, and frame_c) in the HTML code 400 are also changed in the snapshot 410 to resource IDs 413 (i.e., resource_id3, resource_id4, and resource_id5). Similar to CSS, copy images of the iframes 403 are stored as resource IDs 413, and are served directly from the application simulator.

Using snapshots of code along with collected flow-based controls, a simulation generator is able to generate one or more simulated display presentations that include both the non-flow-based content specified in the snapshots and the flow-based controls that were collected. While the above example describes an HTML code and its snapshot, any markup language or custom-defined language can be used to define a code for a page and have a snapshot taken for it.

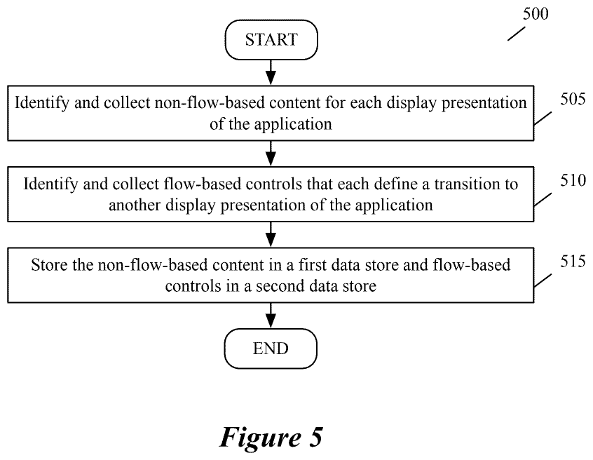

FIG. 5 conceptually illustrates a process 500 of some embodiments for collecting content of an application. This process 500 is performed in some embodiments by a simulation generator of an application simulation system that collects content for the application to be used to create a simulation of the application. The process 500 will be described in relation to FIG. 1, however the process 500 can be performed by any simulation generator that collects information relating to an application in order to generate a simulation of the application.

The process 500 begins by identifying (at 505) and collecting non-flow-based content for each display presentation of the application. The simulation generator 100 collects, from each display presentation 107 of the application, all non-flow-based content. For example, the simulation generator 100 collects non-flow-based content 1-3 from display presentation 1, non-flow-based content 4-5 from display presentation 2, and non-flow-based content A from display presentation N.

In some embodiments, the collected non-flow-based content includes at least one of (1) different sets of code or data that describe the display presentations 107 provided by the application 105 and (2) different images that are part of the display presentations 107. The different sets of code, when processed, produce the display presentations 107 that are to be displayed in a UI (such as UI 150) to present the application 105. For example, these different sets of code are defined in some embodiments as different sets of markup language code (e.g., HTML code) that are used to define each display presentation 107 and its visual components. Any markup language or custom-defined language may be used to define the sets of code specifying the non-flow-based content.

The simulation generator 100 in some embodiments identifies the non-flow-based content by examining, in the UI 150 or another UI, each particular display presentation to identify a particular set of non-flow-based content included in that display presentation. In such embodiments, the simulation generator 100 is notified, by an administrator of the application 105, that a recording of the application 105 in the UI has been initiated. This recording allows the simulation generator 100 to view the administrator's interaction with the application 105 in the UI to identify the non-flow-based content in each display presentation. Further information regarding recording an application in a UI to collect content will be described below.

In some embodiments, rather than examining the application 105 in a UI, the simulation generator 100 identifies non-flow-based content from a set of code associated with the application 105. In such embodiments, the set of code associated with the application 105 is a source code of the application 105. This source code defines the entire application 105 and its components, including the flow-based controls and non-flow-based content of the display presentations 107. By performing code analysis on the source code, the simulation generator 100 can identify and collect all of the non-flow-based content.

The simulation generator 100 in some embodiments requests the source code from an application server (not shown) that implements the application 105. This application server implements the application 105 and stores the source code needed to implement the application 105. Alternatively, the simulation generator 100 in some embodiments retrieves the source code from a data storage storing the source code of the application 105. In such embodiments, the simulation generator 100 has access to this data storage and is authorized to access the source code without requesting it from the application server.

Rather than examining the application 105 in a UI or examining the entire source code of the application 105, the simulation generator 100 in some embodiments sends, to the application server that implements the application 105, a set of one or more API requests requesting the set of code associated with the application 105. In such embodiments, the simulation generator 100 receives, from the application server, a set of one or more API responses that includes the requested set of code. This set of code in such embodiments may be the entire source code or only a portion of it. The simulation generator 100 may only receive a portion of the source code if the application server determines that, based on the API requests, the simulation generator 100 only needs this portion.

Next, the process 500 collects (at 510) and identifies flow-based controls that each defines a transition to another display presentation of the application. The simulation generator 100 collects, from each display presentation 107 of the application 105, all flow-based controls. For example, the simulation generator 100 collects flow-based controls 1-2 from display presentation 1, flow-based control 3 from display presentation 2, and flow-based control Z from display presentation N.

The simulation generator 100 in some embodiments identifies the flow-based controls using the recording method described above. For this method, the simulation generator 100 detects, in a UI, selections of different selectable elements of the application 105 that cause different display presentations to be displayed in the UI. In such embodiments, each flow-based control is represented in each of the display presentations 107 by a different selectable element. When a selectable element is selected in the UI, the simulation generator 100 detects that the associated flow-based control is being selected. Selection of a selectable element can include detecting a cursor selection (e.g., a single or double click using a cursor) of the selectable element or any other operation to select a UI element (e.g., keyboard input).

After detecting a selection of a selectable element, the simulation generator 100 in some embodiments associates the selectable element to its respective display presentation that is displayed upon selection of that selectable element. This association defines the flow-based control. In such embodiments, each flow-based control is defined using a selectable element as its source and a display presentation as its destination. This display presentation is the display presentation to which the application 105 transitions upon selection of the selectable element, and not the initial (i.e., source) display presentation that displays the source selectable element. By not defining a flow-based control based on its source output display presentation, the simulation generator 100 is able to identify the same flow-based control in other display presentations, as long as the source selectable element and destination display presentation are the same.

For example, the simulation generator 100 in some embodiments examines a first display presentation displayed in a UI. During this examination, the simulation generator 100 collects a first set of non-flow-based content for the first display presentation. Upon detection of a selection of a selectable element that causes a second display presentation to be displayed in the UI, the simulation generator 100 collects this flow-based control by associating the selected selectable element to the second display presentation. Then, the simulation generator examines the second display presentation to collect a second set of non-flow-based content for the second display presentation. Other than recording the application 105 in a UI, the simulation generator 100 can collect the flow-based controls similarly to the collection of the non-flow-based content (e.g., accessing the source code, using APIs).

Lastly, the process 500 stores (at 515) the non-flow-based content in a first data store and the flow-based controls in a second data store. The simulation generator 100 stores the collected non-flow-based content in the non-flow-based content data store 125 and the flow-based controls in the flow-based control data store 120 so it can be used by the simulation player 130 or the simulation generator 100 (or a simulation pre-renderer (not shown), in some embodiments) to generate the simulated display presentations 140. In some embodiments, the data stores 120 and 125 are part of a single data storage. In other embodiments, they are completely separate data storages. Any suitable storage arrangement can be used for storing flow-based controls and non-flow-based content.

In some embodiments, each of the non-flow-based content is stored once in its data store 125, even if the same non-flow-based content is identified in multiple display presentations. Each flow-based control is in some embodiments stored only once in the data store 120. This is done in some embodiments to save space in the data store 120, and because only one entry is needed. In such embodiments, if a flow-based control is identified more than once, it is only stored upon its first identification by the simulation generator 100.

For example, the simulation generator 100 in some embodiments identifies a particular flow-based control from a particular selectable element included in a first display presentation that transitions the application 105 to a second display presentation. Upon identifying the particular flow-based control, the simulation generator 100 determines whether an entry for it is already stored in the data store 120 (e.g., by examining entries stored in the data store 120). If an entry is already stored (i.e., the particular flow-based control was already identified and stored by the simulation generator 100), the simulation generator 100 does not store a second entry for the particular flow-based control. If an entry is not already stored (i.e., the particular flow-based control has not yet been identified and stored by the simulation generator 100), the simulation generator 100 stores an entry for it in the data store 120. After storing the non-flow-based content and flow-based controls, the process 500 ends.

The non-flow-based content and the flow-based controls are stored in separate data stores 120 and 125. By collecting and storing non-flow-based content and flow-based controls separately, the simulation generator 100 can re-collect any of this information (e.g., when any of the information is changed in the application 105) without having to re-collect anything that was not changed.

The set of flow-based controls and the different sets of non-flow-based content are stored in the data stores 120 and 125 in some embodiments to generate the simulated display presentations 140 to provide the simulated operations of the application 105. In such embodiments, the simulation player 130 or the simulation generator 100 combines the flow-based controls and the non-flow-based content to generate replicas (i.e., the simulated display presentations 140) of the application's display presentations 107. These simulated display presentations 140 can be presented to a user (e.g., through the UI 150) for the user to learn how to use the application 105 without actually using or accessing the application 105.

In some embodiments, the process 500 is performed for a single standalone application. In such embodiments, the simulation generator 100 provides simulated operations of the single standalone application. The single standalone application can be a single web-based application. This web-based application can be implemented by an application server accessible through a cluster of one or more web servers. In such embodiments, the web server cluster facilitates access to the application server and the web-based application. The application server can be a part of a cluster of one or more application servers that executes on one or more virtual machines, Pods, or standalone server computers in a datacenter (e.g., private datacenter, public datacenter). The cluster of web servers can also execute on one or more virtual machines, Pods, or standalone server computers in a public or private datacenter.

In other embodiments, the process 500 can be performed to provide simulated operations of a set of two or more applications. In such embodiments, the simulation generator 100 generates a simulation that simulates the set of applications. The application set in some embodiments includes two or more web-based applications that are implemented by two or more different clusters of two or more application servers. In such embodiments, the web-based applications can be accessed through a same set of one or more web servers through or different sets of one or more web servers.

The above-described simulation generator 100 is in some embodiments part of an application simulation system that provides the simulated display presentations 140 as a highly interactive practice environment for the application 105. This application simulation system has simplified creation, deployment, and maintenance capabilities that are targeted towards both onboarding and hands-on training needs. Using this application simulation system provides significant reduction in training cost due to its lesser cost to acquire, deploy, and maintain the simulated application (i.e., the simulated display presentations 140).

The application simulation system in some embodiments also provides (1) faster onboarding, (2) a realistic simulated environment with DAP guidance executing on top of the simulated display presentations 140 that enables effective and interactive training for users, and (3) an increase in adoption that provides better familiarity with application processes and workflows that results in better adoption and reduced support costs. The application simulation system, including the simulation generator 100, makes it much simpler to create and maintain a simulated environment (e.g., to use for training a user to use the application from which the simulated environment was created).

In some embodiments, a simulation of an application is updated based on modifications made to the application. In such embodiments, simulated display presentations generated for display presentations of an application are automatically updated when the display presentations are modified. In these embodiments, if a change is made to the application, the change is automatically detected by, e.g., periodically scanning the application. Once a change is detected, one or more simulated display presentations corresponding to the impacted display presentation(s) of the application are automatically regenerated to reflect the change. In some of these embodiments, the regenerated simulated display presentation(s) are presented to the application's administrator for the administrator to review, test, and approve the regenerated simulated display presentation(s). However, the application simulation system can alternatively replace the previously generated simulated display presentation(s) with the regenerated simulated display presentation(s) without administrator review or approval.

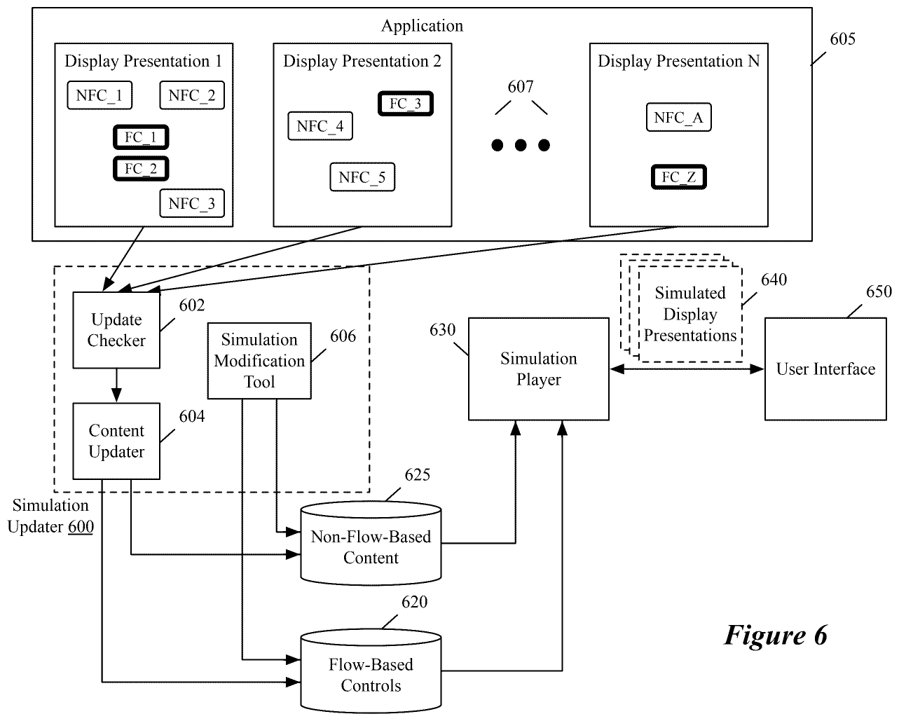

FIG. 6 illustrates an example simulation updater 600 that automatically updates information stored for the application 605 and its display presentations 607 in the data stores 620-625. In this example, the application 605 includes a set of one or more display presentations 607, and can include any number of display presentations. Each display presentation 607 can include any amount of non-flow-based content and any number of flow-based controls.

In this figure, the non-flow-based data store 625 stores non-flow-based content that is collected for the application 605 (e.g., by a simulation generator similar to the simulation generator 100 of FIG. 1). The flow-based control data store 620 stores flow-based controls that are collected for the application 605. The non-flow-based content and flow-based controls stored respectively in the data stores 625 and 620 are used to generate a set of simulated display presentations 640 to represent a simulation of the application 605. The simulated display presentations 640 are displayed, by the simulation player 630, to a user through a user interface 650 for the user to simulate using the application 605.

The simulation updater 600 includes an update checker 602, a content updater 604, and a simulation modification tool 606. The update checker 602 is responsible for determining when any non-flow-based content or any flow-based controls change in the display presentations 607. For example, the update checker 602 in some embodiments detects that non-flow-based content 1 has been modified (e.g., the text has been edited). As another example, the update checker 602 in some embodiments detects that flow-based control 3 has been changed (e.g., its destination display presentation has changed, or its selectable element has changed locations or changed in size, color, or font). Conjunctively or alternatively, the update checker 602 in some embodiments receives notification from the administrator or developer of the application 605 when any non-flow-based content or flow-based controls have changed.

In some embodiments, the update checker 602 detects a change to non-flow-based content or flow-based controls by iteratively collecting the non-flow-based content and flow-based controls from the display presentations 607 to compare it to the non-flow-based content and flow-based controls stored in the data stores 620 and 625. If the update checker 602 detects a difference between the newly collected content and controls and the content and controls stored in the data stores 620 and 625, the update checker 602 determines that there has been a change to at least some of the content and/or at least one control since the last collection it performed.

To iteratively collect the non-flow-based content and flow-based controls from the display presentations 607, the update checker 602 in some embodiments iteratively examines the source code of the application 605 to re-collect the source code of the display presentations 607 and determine whether any of the non-flow-based content or any flow-based controls have changed since they were last stored in the data stores 620 and 625. When the update checker 602 has access to the source code, the update checker 602 is able to iteratively examine it to identify any changes that have been made to it.

In other embodiments, the update checker 602 uses APIs to iteratively collect non-flow-based content or flow-based controls. In such embodiments, the update checker 602 iteratively sends API requests to a set of one or more application servers (not shown) of the application 605 to request one or more subsets of code of the application's source code. These requested code subsets define the non-flow-based content and flow-based controls of the application 605. When the update checker 602 receives the requested code subsets, the update checker 602 identifies the non-flow-based content and flow-based controls defined in the code subsets and compares them to the stored versions in the data stores 620 and 625 to identify any changes.

Conjunctively or alternatively to examining the source code or requesting subsets of code through APIs, the update checker 602 in some embodiments identifies whether the administrator of the application 605 has indicated whether any of the display presentations 607 have been modified. In such embodiments, the administrator marks each display presentation (e.g., with a tag, a flag, etc.) that has been modified, and the update checker 602 examines the display presentations 607 to identify these marks. If the update checker 602 identifies a mark on any of the display presentations, the update checker 602 knows that these display presentations have been modified and at least some of their content has to be updated in the data store 620 and/or 625.

When the content of the display presentations 607 are initially recorded (e.g., in a user interface presenting the application 605 to the administrator) to collect the non-flow-based content and flow-based controls, the update checker 602 in some embodiments iteratively (or as directed by the administrator) re-records the application 607 to recapture the display presentations 607. In such embodiments, the update checker 602 compares the re-captured display presentations to the content and controls stored in the data stores 620 and 625 to determine if any content or controls have been modified.

When the update checker 602 determines that there has been a change in any of the display presentations 607, the update checker 602 re-collects the content or control that has changed. Then, the update checker 602 provides the re-collected content or control to the content updater 604. In other embodiments, the update checker 602 notifies the content updater 604 of the changed content, and the content updater 604 re-collects the content directly. The update checker 602 in some embodiments will take a new snapshot for the display presentation that changed (e.g., when non-flow-based content of the display presentation has changed).

When the simulation updater 600 has access to the application's source code, the modified non-flow-based content or flow-based control(s) can be collected directly from the source code. When the simulation updater 600 does not have access to the entire source code but can send API requests to the application server set of the application 605, the modified non-flow-based content or flow-based control(s) can be collected from the received requested code subsets. When the simulation updater 600 records the display presentations 607 through a user interface (i.e., when it has no access to any source code of the application 605), the content updater 604 re-records the modified content. Conjunctively or alternatively, the simulation updater 600 in some embodiments notifies the administrator of each display presentation that has to be re-recorded.

The content updater 604, after receiving or re-collecting the updated content or control, modifies the data stored in at least one of the respective data stores 620 or 625. For example, when non-flow-based content A is updated, the content updater 604 replaces its previously collected content information in the data store 625 with its newly collected content information. As another example, when flow-based control 2 is updated, the content updater 604 replaces its previously collected control information in the data store 620 with its newly collected control information.

The simulation modification tool 606 is responsible for making edits to the simulated display presentations 640 based on input received regarding edits that are to be made to the simulated displayed presentations 640. These edits are not made based on edits or updates to the actual display presentations 607. For example, the simulation modification tool 606 in some embodiments receives, from an administrator of the application 605, that non-flow-based content 2 is to be changed in the simulated display presentations 640, even though it will not be edited in the display presentations 607 of the actual application 605. Such edits can be made because the administrator wishes to change or remove some content of the application 605 (e.g., PII data) from the simulation of the application 605. Further information regarding operations of the simulation modification tool 606 will be described below.

By separately collecting the non-flow-based content and flow-based controls, the simulation updater 600 only has to re-collect and store updated information. The simulation updater 600 does not have to re-collect any other information from the display presentations 607 that has not changed. This is due to the decoupling of the non-flow-based content and flow-based content in terms of its collection and storage.

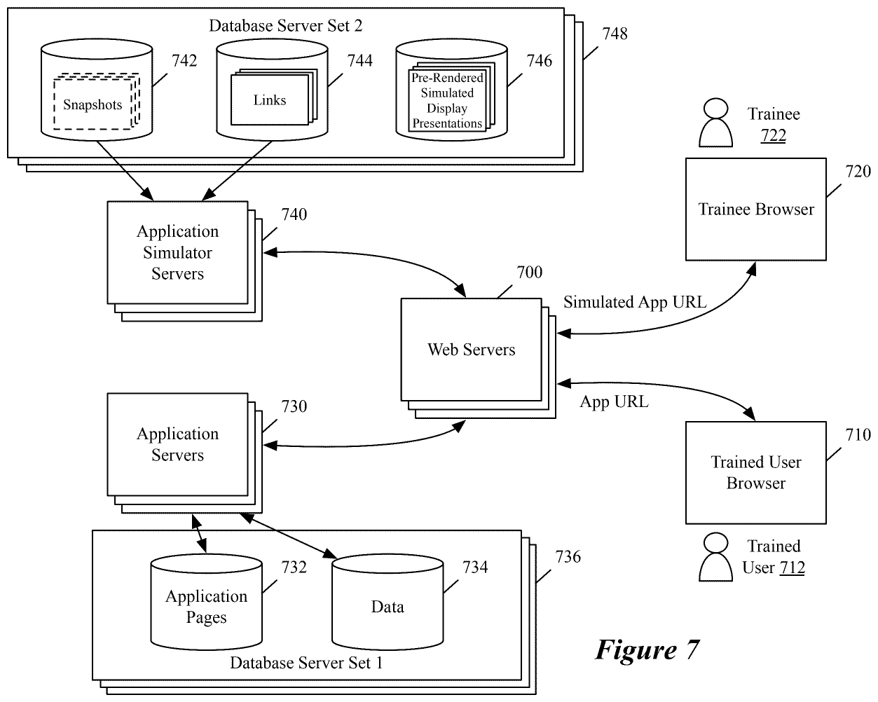

Simulated display presentations that have been generated to simulate operations of an application can be accessed by one or more users. In some embodiments, the simulated display presentations are accessed differently than the actual application. For example, some embodiments generate a URL to access a simulated application (i.e., for its simulated display presentations) that is different from the URL used to access the actual application (e.g., when the application is a web application). FIG. 7 illustrates a set of one or more web servers 700 that facilitates access to a set of one or more application servers 730 for a trained user 712 and facilitates access to a set of one or more application simulator servers 740 for a trainee 722. The trained user 712 accesses the application server set 730 through their trained user browser 710 using an application URL, while the trainee 722 accesses the application simulator servers 740 through their trainee browser 720 using a simulated application URL.

The application server set 730 uses an application page storage 732 and a data storage 734 that reside on a first set of one or more database servers 736. The application page storage 732 and data storage 734 store the pages and data needed for an application to which the trained user 712 is accessing in their browser 710.

In this example, the application server set 730 is providing a web application that is accessible through a browser (e.g., the trained user browser 710) via the web server set 700. Therefore, the application URL is provided to the trained user 712, and is input into the browser 710 to access the application server 730. Through the browser 710, the trained user 712 can access the application.

An application simulator server set 740 in some embodiments accesses snapshots in a first storage 742, links in a second storage 744, and pre-rendered simulated display presentations in a third storage 746 to simulate the application for the trainee 722. The links stored in the storage 744 can be local and/or global links. The snapshot storage 742, link storage 744, and pre-rendered simulated display presentation storage 746 reside on a second set of one or more database servers 748. The application simulator server set 740 in some embodiments does not have access to the application page storage 732 or data storage 734 of the actual application, and only uses the information stored on the second database server set 748 to simulate the application.

The simulated application URL is provided to the trainee 722 so they can access the simulated application in order to learn how to use the application without actually accessing the application. The simulated application URL is a different URL than the application URL so that the simulated application can be accessed separately from the application.

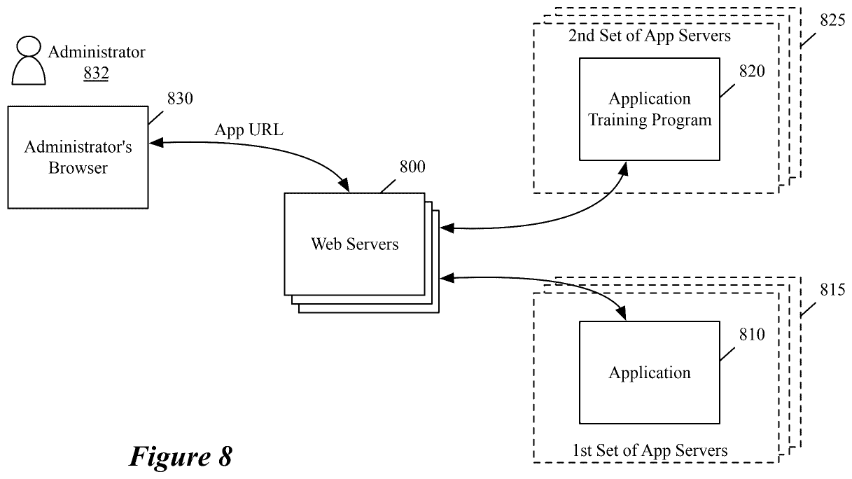

In some embodiments, a set of web servers is also used to facilitate an administrator's access to an application and an application training program used to generate a simulation of the application. FIG. 8 illustrates a set of one or more web servers 800 that facilitates access of an application 810 and an application training program 820 in an administrator's browser 830 for an administrator 832 of the application 810. Through the browser 830, administrator 832 is able to access (1) the application 810 to develop and/or use the application 810 and (2) the application training program 820 to generate a training simulation of the application 810.

The application 810 executes on a first set of one or more application servers 815. The application training program 820 executes on a second set of one or more application servers 825. However, in other embodiments, at least one application server can execute at least a portion of the application 810 and the application training program 820.

The application 810 in this example is a web application accessible through the browser 830 via the web server set 800. The application training program 820 is a program that is provided through the browser 830 as a browser extension via the web server set 800. In such embodiments, the application 810 and application training program 820 reside respectively on the sets of application servers 815 and 825, and the web server set 800 facilitates the access of the application 810 and application training program 820 in the administrator's browser 830.

In the browser 830, the administrator 832 is able to access the application 810 on the first application server set 815 to develop, maintain, and use the application 810. In the browser 830, the administrator 832 also able to access the application training program 820 on the second application server set 825 to generate and maintain a simulation of the application 810. This simulation is created in some embodiments for the administrator 832 to provide to one or more users to train them on using the application 810 (without actually accessing the application 810). The simulation may execute on the same set of application servers 825 as the application training program 820 or on a different set of application servers.

In some embodiments, the administrator 832 accesses the application training program 820 through the browser 830 to generate guided training of the created simulation. In such embodiments, the administrator 832 creates training display presentations that are to be displayed along with the simulation (e.g., as popup windows) to guide the users through each simulated display presentation of the simulation and the flows of the simulation. These training display presentations can be generated as part of the simulation or as a separate program that is accessed along with the simulation. These training display presentations can also be presented within or on top of the application 810 to provide guided training through the application 810.

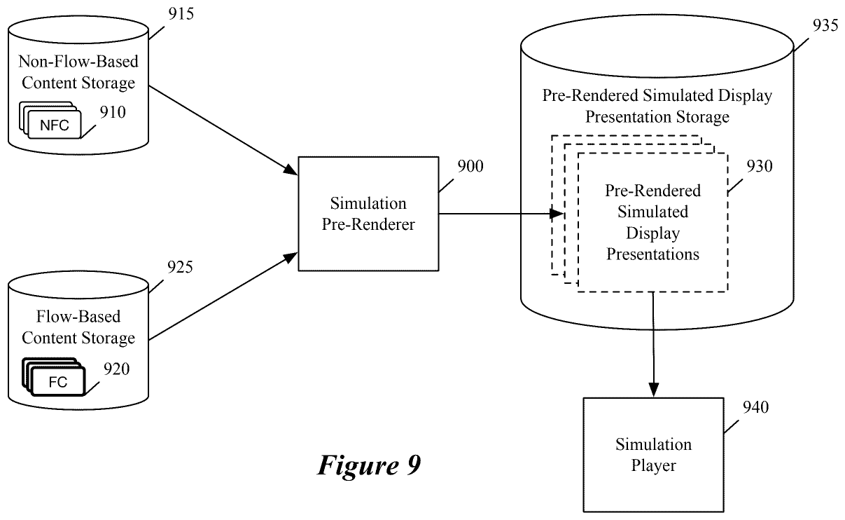

Before a simulation of an application is accessed by a user, some embodiments pre-render the simulated display presentations of the simulation. In such embodiments, the simulated display presentations are ready to be presented to a user before they are actually needed, saving compute time during presentation of the simulation. FIG. 9 illustrates an example simulation pre-renderer 900 that uses non-flow-based content 910 and flow-based content 920 to generate a set of pre-rendered simulated display presentations 930 for an application (not shown). The application can include any amount of non-flow-based content 910 and flow-based content 920.

In this example, the simulation player 900 retrieves the non-flow-based content (e.g., text, images) 910 from a first data store 915 and the flow-based content 920 (e.g., flow-based controls, elements) from a second data store 925. Other embodiments may store the non-flow-based content 910 and flow-based content 920 in a same data store.

In some embodiments, the non-flow-based content 910 (e.g., text, images, and other non-selectable content of the application) is specified in snapshots (i.e., copies of code, such as HTML code) taken for different display presentations of the application. A snapshot of a display presentation is a point-in-time copy of a display presentation and at least its non-flow-based content. It may also include IDs of flow-based content or actual non-flow-based content. In such embodiments, the simulation pre-renderer 900 can retrieve snapshots from the data store 915, as the snapshots include the non-flow-based content 910.

The flow-based content storage 925 stores, for the flow-based controls 920, different attributes of each flow-based control. For example, the storage 925 in some embodiments stores, for each flow-based control, a source element of the flow-based control, a destination display presentation of the flow-based control, and a type (e.g., local, global) of the flow-based control. The storage 925 may also store attributes of different source elements, such as the text, class, and appearance of each source element. Using this information, the simulation pre-renderer 900 can generate the flow-based controls for the pre-rendered simulated display presentations 930.

Based on the non-flow-based content 910 and the flow-based controls 920, the simulation pre-renderer 900 generates the pre-rendered simulated display presentations 930 to store in a pre-rendered simulated display presentation storage 935. When interacted with, the pre-rendered simulated display presentations 930 will act the same as the actual display presentations of the application, but the application will not be invoked.

Once the pre-rendered simulated display presentations 930 have been stored in the storage 935, a simulation player 940 in some embodiments is able to present them to a user. The simulation player 940 can present the pre-rendered simulated display presentations 930 through a UI, such as a GUI. When the application is a web-based application, the simulation player 940 can present the simulated display presentations 930 through a web browser using a cluster of one or more web servers.

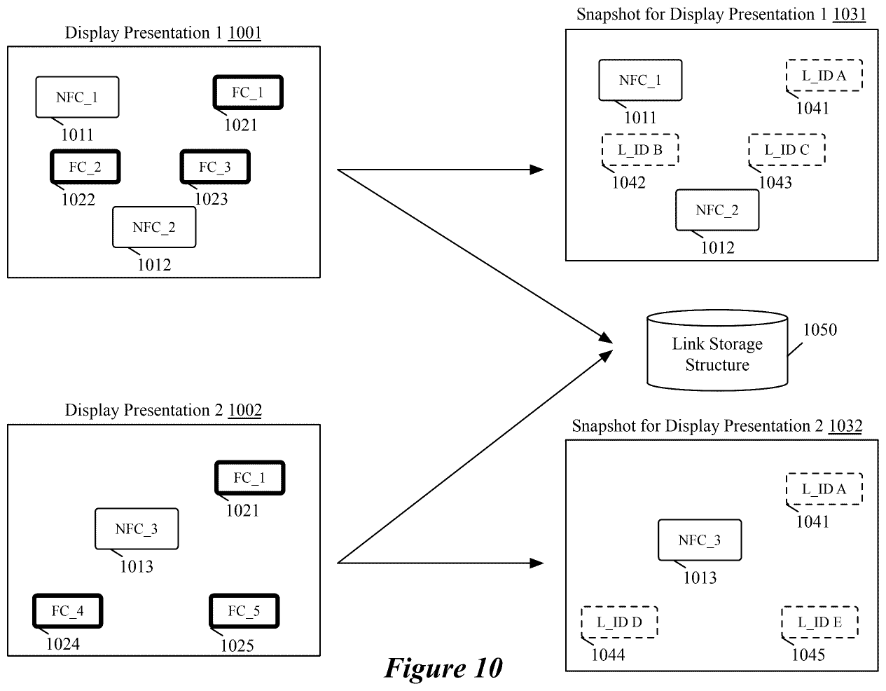

As discussed previously, non-flow-based content of display presentations is in some embodiments specified in snapshots taken from code (e.g., HTML code) defining the display presentations. In some of these embodiments, the snapshots also specify IDs for different flow-based controls of the display presentations. As such, the snapshots can be used along with definitions of the flow-based controls to generate (e.g., pre-render) simulated display presentations. FIG. 10 illustrates first and second display presentations 1001-1002 and first and second snapshots 1031-1032 taken for the display presentations 1001-1002. In this example, display presentation 1001 includes non-flow-based content 1011-1012 and flow-based controls 1021-1023, and display presentation 1002 includes non-flow-based content 1013 and flow-based controls 1021 and 1024-1025.

Different display presentations are in some embodiments identified from web pages of a web application. In some embodiments, one or more of these web pages are described in HTML. In the example of FIG. 10, the display presentations 1001-1002 are part of a web application and are described in HTML, which is a markup language. In other embodiments, pages of an application are described in another markup language or in another language that is not a markup language, but is a custom-defined language for the application. The application may also not be a web application.

To capture the content 1011-1013 and flow-based controls 1021-1025, the snapshots 1031-1032 are taken for each of the display presentations 1001-1002. A first snapshot 1031 is taken for display presentation 1001, and a second snapshot 1032 is taken for display presentation 1002. The first snapshot 1031 specifies the non-flow-based content 1011-1012, and specifies link IDs 1041-1043. Link ID 1041 corresponds to flow-based control 1021, link ID 1042 corresponds to flow-based control 1022, and link ID 1043 corresponds to flow-based control 1023. The second snapshot 1032 specifies the non-flow-based content 1013, and specifies link IDs 1041 and 1044-1045. Link ID 1041 corresponds to flow-based control 1021 (as in snapshot 1031), link ID 1044 corresponds to flow-based control 1024, and link ID 1045 corresponds to flow-based control 1025.

Because both display presentations 1001 and 1002 include flow-based control 1021, both snapshots 1031 and 1032 specify the corresponding link ID 1041. This means that both display presentations 1001 and 1002 include a flow-based control that, when selected in a UI, causes the UI to display another particular display presentation (not shown). This link is referred to as a global link. The other flow-based controls 1022-1025 in the display presentations 1001-1002 each leads to a different other display presentation (not shown) These other flow-based controls 1022-1025 may be global links or local links.

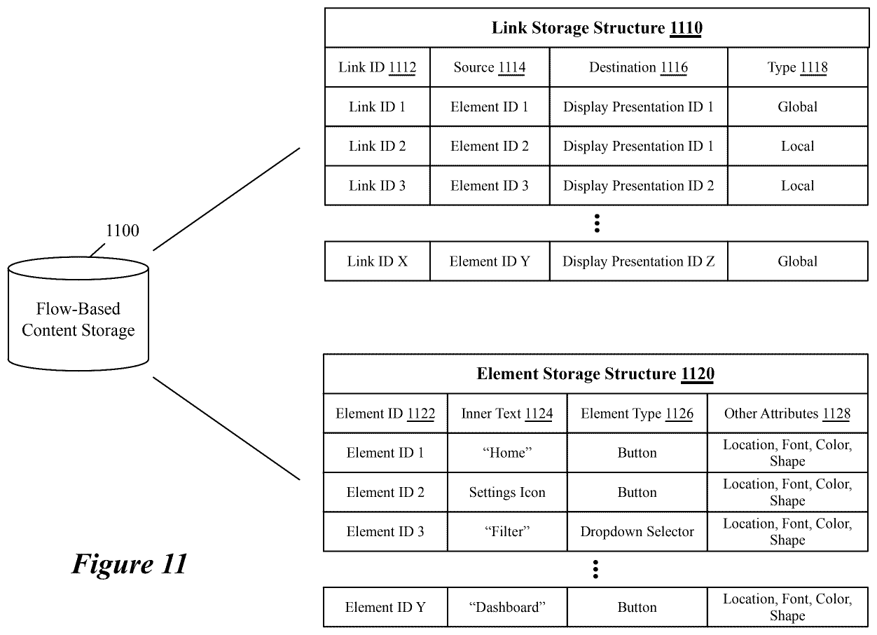

The information regarding the flow-based controls 1021-1025, while being included in the snapshot 1031-1032, are also stored in a link storage structure 1050. This storage structure 1050 stores, for each flow-based control 1021-1025, a set of one or more attributes. These attributes allow an application simulation system to correctly simulate the appearance and operation of the flow-based controls 1021-1025. Further information regarding attributes of a link will be described below in relation to FIG. 11.

A simulation generator in some embodiments captures snapshots (i.e., code copies) for display presentations of an application so that the simulation generator or a simulation pre-renderer can accurately generate simulated display presentations corresponding to the application's display presentations. The snapshots and the flow-based controls that are collected and stored are retrieved and combined in order to map the non-flow-based content specified in the snapshots and the flow-based controls to the correct display presentation and the correct location in the correct display presentation. In the example of FIG. 10, a simulation generator in some embodiments collects the information regarding the flow-based controls 1021-1025, which is stored in a set of data stores (including the data store 1050 storing the flow-based control data). The simulation generator also captures and stores the snapshots 1031-1032 to capture and store the non-flow-based content 1011-1013. Then, the simulation generator or a simulation pre-renderer can combine the flow-based controls 1021-1025 with the non-flow-based content 1011-1013 (i.e., the snapshots 1031-1032) to generate simulated display presentations for the display presentations 1001-1002.

As discussed previously, attributes of flow-based controls (e.g., links) of an application are collected and stored in order to simulate the link in a simulation of the application. Some embodiments provide decoupling of these flow-based controls and generated simulated display presentations. In such embodiments, the links between simulated display presentations (e.g., a link specifying that Element A leads to Simulated Display Presentation 2) are stored separately. If a particular simulated display presentation has multiple outgoing links to one or more other simulated display presentations and the particular simulated display presentation is updated (e.g., any non-flow-based content is re-collected and used to generate a new version of the simulated display presentation), these outgoing links are all preserved, reducing the maintenance effort. More specifically, while the particular simulated display presentation is being updated, none of its outgoing links have to be re-captured.

To store a reference for an element (e.g., Element A), some embodiments use an element detection algorithm. This algorithm is able to store one or more attributes related to the element so that the same element can be detected in the application, even when there are structural changes to the element when the screen is re-captured. For example, the font of a home button element in some embodiments is changed, but the application simulation system is able to still identify the element even though it has visually changed. Methods and systems regarding element detection are further described in U.S. Pat. Nos. 11,461,090 and 11,846,967, which are incorporated by reference in this application.

FIG. 11 illustrates an example data store 1100 that stores flow-based content for an application. In this example, the storage 1100 includes a link storage structure 1110 and an element storage structure 1120. The link storage structure 1110 stores entries for each link (i.e., flow-based control) of the application. The element storage structure 1120 stores entries for each element of the application. These elements are selectable items of the application that are the “sources” of the links.

The link storage structure 1110 includes a link ID column 1112, a source column 1114, a destination column 1116, and a type column 1118. For each link, the link ID column 1112 specifies a unique identifier associated with that link. For each link, the source column 1114 specifies a unique identifier associated with the element that is the source of the link. For example, link ID 1 is associated with element ID 1, meaning that element 1 is the source of link 1. These unique identifiers for the elements are in some embodiments different from the HTML element IDs associated with the elements, as HTML element IDs do not have to be unique.

For each link, the destination column 1116 specifies a unique identifier for a display presentation that is the destination of the link. For example, link ID 2 is associated with element ID 2 and display presentation ID 1, which means that upon selection of element 2 in the application, link 2 is invoked and display presentation 1 will be shown in the application. Any suitable type of identifier can be used for links, elements, and display presentations. In some embodiments, a same type of identifier is used for all links, elements, and display presentations. In other embodiments, at least two of the links, elements, and display presentations use different types of identifiers.

For each link, the type column 1118 specifies whether the link is a global link or a local link. A global link is a link that is applied across all display presentations that include the source element of the link. For example, link 1 is a global link, such that when element 1 is identified in any of the application's display presentations, link 1 is applied. Defining a global link based on its source element and its destination display presentation and regardless of its source display presentation significantly reduces the maintenance effort of the application simulation system that creates and maintains these links in the storage structure 1110 for a simulation.

A local link is applied on only one display presentation, even if the source element is identified in other display presentations. For example, link 2 is a local link, so even if element 2 is identified in multiple display presentations, link 2 is only applied once. In some embodiments, the application's administrator specifies to the simulation generator whether each link is a local or global link. Upon receiving these specifications from the administrator, the simulation generator records the type information in the link storage structure 1110.

As shown in the link storage structure 1110, links 1 and 2, while they have the same destination display presentation, have different source elements. This means that these two different elements 1 and 2, when selected, cause the same display presentation 1 to be displayed. Even though they have the same destination, the two links are considered different links as their source elements are different.

The element storage structure 1120 includes an element ID column 1122, an inner text column 1124, an element type column 1126, and an “other attributes” column 1128. While four attributes are specified in this structure 1120, some embodiments specify additional and/or different attributes for elements in the storage structure 1120 (e.g., location and attributes of sibling elements, location and attributes of parent elements, distance/path from pillar elements, etc.). For each element, the element ID column 1122 specifies a unique identifier associated with that element. For each link, the inner text column 1124 specifies any inner text displayed in the element in the application. For example, element 1 is a home button, so the inner text is “Home.” Conjunctively or alternatively, an element can have an icon or a picture displayed for it in the application. In such embodiments, the column 1124 specifies a description of that icon or picture. For example, element 2's inner text specifies a settings icon, meaning that this element has an icon to indicate that it is a settings button, rather than specifying text.

For each element, the element type column 1126 specifies the type of the element. For example, elements 1 and 2 are classified as buttons, meaning that they are selectable buttons in the application that lead to (i.e., based on their associated link) a completely new page of the application. Element 3 is classified as a dropdown selector, meaning that it opens up a dropdown menu upon selection. While the entire page of the application does not change upon selection of element 3, the inclusion of the dropdown menu in the application is considered a different display presentation than the display presentation that displays the same page of the application but without the dropdown menu.

For each element, the “other attributes” column 1128 specifies any additional attributes of the button, such as its location in the display presentation that includes the element and the font, color, and shape of the element. Any other attributes of an element can be specified in this column 1128. In some embodiments, a particular set of attribute types is specified for every single element in this column 1128. In other embodiments, different elements are associated with different sets of attribute types specified in this column 1128. These different sets of attribute types may be overlapping (e.g., two elements have at least one same attribute type listed in this column 1128).

The links specified in the link storage structure 1110 only refer to a source element ID as its source in some embodiments in order to separate links from their appearance in the application. In such embodiments, the links are determined by their source attribute, which refers to the element storage structure 1120, and the element storage structure 1120 is created to describe the appearance of the elements. The element storage structure 1120 can also be used along with the link storage structure 1110 to generate simulated display presentations and present them based on user selections of the elements in the simulated display presentations.

The element storage structure 1120 can be used during use of the simulated display presentations to identify which element a user using the simulated display presentations selects. The link storage structure 1110 can be used to identify which display presentation a simulation player should show based on the user's selected element. The storage structures 1110 and 1120 can also be used to pre-render the simulated display presentations before they are presented to a user (rather than rendering each simulated display presentation as they are needed to be presented to the user). The attributes of the elements and links described in the structures 1110 and 1120 enable the simulated display presentations to be pre-rendered. For example, the attributes 1122-1128 of the element storage structure 1120 can be used to accurately pre-render each selectable element of the application, and the attributes 1112-1118 of the link storage structure 1110 can be used to define each link based on its source element and its destination display presentation.

In some embodiments, an administrator of an application wishes to edit (e.g., redact) information, that is displayed in the application, in the simulation of the application. For example, the administrator in some embodiments wishes to redact personally identifiable information (PII) data from an application's simulation (e.g., a name, email, phone number, etc.) even though it is displayed in at least one display presentation of the actual application. In such embodiments, a simulation updater can make these edits to one or more generated (e.g., pre-rendered) simulated display presentations that include the PII data to be redacted. The administrator may direct the simulation updater to make any edits to content in simulated display presentations.

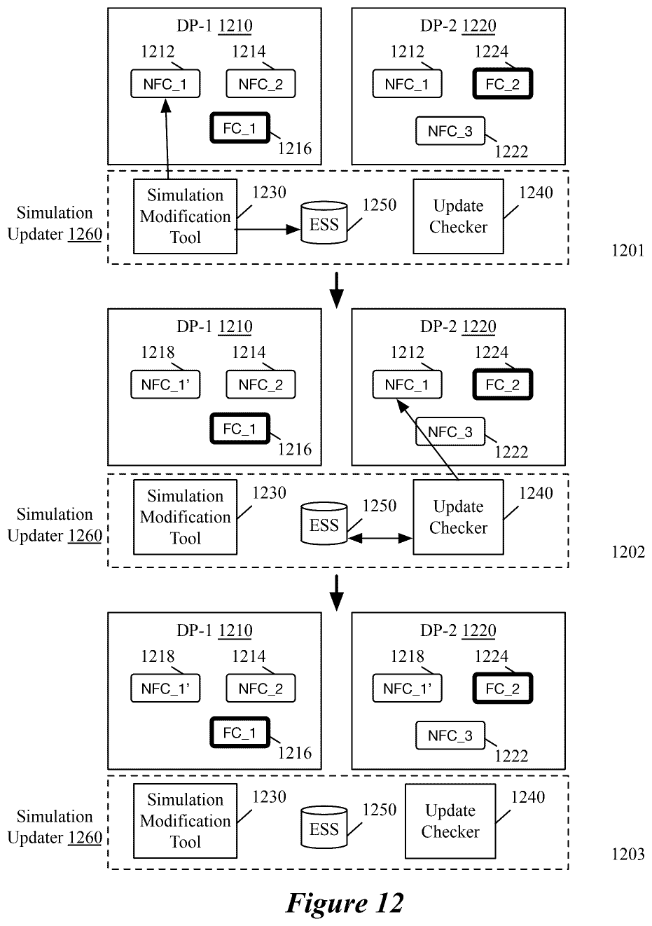

FIG. 12 illustrates an example simulation modification tool 1230 and update checker 1240 that facilitate administrator non-flow-based content edits to a simulated application. The simulation modification tool 1230 and update checker 1240 are part of a simulation updater 1260 along with an edits storage structure 1250. In this example, the simulated application includes two simulated display presentations 1210 and 1220, however, the simulated application can include any number of simulated display presentations.

The first simulated display presentation 1210 includes non-flow-based content 1212 and 1214 and flow-based control 1216. The second simulated display presentation 1220 includes non-flow-based content 1212 and 1222 and flow-based control 1224. Any amount of non-flow-based content and any number of flow-based controls can be included in each simulated display presentation 1210 and 1220, however a finite amount is displayed in this figure for brevity.

The simulation modification tool 1230 is responsible for receiving editing directions from the application's administrator, applying those edits, and storing the edits in the edits storage structure 1250. The update checker 1240 is responsible for monitoring (e.g., periodically examining) the edits storage structure 1250 to identify new edits and globalize the new edits.

The simulated display presentations 1210 and 1220 are initially generated by a simulation generator based on all of the information of the application. After creation (or during creation, in some embodiments) of the simulated presentations 1210 and 1220, at stage 1201, the simulation modification tool 1230 receives notification from the application administrator to edit non-flow-based content 1212 in the first simulated display presentation 1210. This edit can be to edit some or all of the content 1212 in the simulated display presentation 1210, or can be to completely redact it from the simulated display presentation 1210. After receiving this notification, the simulation modification tool 1230 identifies the content 1212 in the simulated display presentation 1210 that is to be edited and edits it based on the administrator's direction.

At 1201, the simulation modification tool 1230 also adds an entry to the edits storage structure 1250 to specify that non-flow-based content 1212 is to be edited to non-flow-based content 1218 (based on the administrator's notification). This entry can be used by the update checker 1240 to globalize this edit to the other simulated display presentations of the application. Conjunctively or alternatively, the simulation modification tool 1230 notifies the update checker 1240 of any edits it makes so the update checker 1240 can globalize the edits.

At stage 1202, non-flow-based content 1212 has been edited by the simulation modification tool 1230 to non-flow-based content 1218, which is now displayed in the simulated display presentation 1210. At this stage, the update checker 1240 identifies, from the edits storage structure 1250, any edits that need to be made to any of the simulated display presentations of the application. In this example, the update checker 1240 identifies the edit to change non-flow-based content 1212 to non-flow-based content 1218, which the simulation modification tool 1230 has already done in the first display presentation 1210. After determining this, the update checker 1240 updates the non-flow-based content 1212 in the second simulated display presentation 1220 to non-flow-based content 1218.

At stage 1203, non-flow-based content 1212 in the second simulated display presentation 1220 has been edited by the update checker 1240 to non-flow-based content 1218. As such, the edit has been made to all of the necessary content of the simulated display presentations 1210 and 1220.

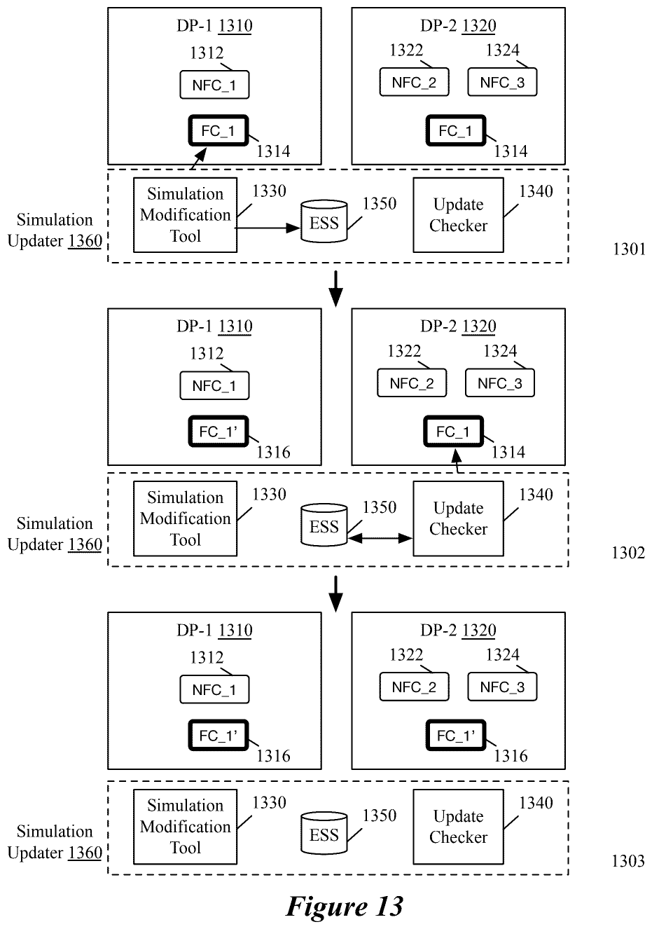

While the above example describes an edit made to non-flow-based content, edits can also be made to flow-based content. FIG. 13 illustrates an example simulation modification tool 1330 and update checker 1340 that facilitate administrator flow-based content edits to a simulated application. The simulation modification tool 1330 and update checker 1340 are part of a simulation updater 1360 along with an edits storage structure 1350. In this example, the simulated application includes two simulated display presentations 1310 and 1320, however, the simulated application can include any number of simulated display presentations.

The first simulated display presentation 1310 includes non-flow-based content 1312 and flow-based control 1314. The second simulated display presentation 1320 includes non-flow-based content 1322 and 1324 and flow-based control 1314. Any amount of non-flow-based content and any number of flow-based controls can be included in each simulated display presentation 1310 and 1320, however a finite amount is displayed in this figure for brevity.

The simulation modification tool 1330 is responsible for receiving editing directions from the application's administrator, applying those edits, and storing the edits in the edits storage structure 1350. The update checker 1340 is responsible for monitoring (e.g., periodically examining) the edits storage structure 1350 to identify new edits and globalize the new edits.

The simulated display presentations 1310 and 1320 are initially generated by an simulation generator based on all of the information of the application. After creation (or during creation, in some embodiments) of the simulated presentations 1310 and 1320, at stage 1301, the simulation modification tool 1330 receives notification from the application administrator to edit flow-based control 1314 in the first simulated display presentation 1310. This edit can be to edit the element associated the flow-based control 1314, to change its destination simulated display presentation, or any suitable edit for a flow-based control. After receiving this notification, the simulation modification tool 1330 identifies the flow-based control 1314 in the simulated display presentation 1310 that is to be edited and edits it based on the administrator's direction.

At 1301, the simulation modification tool 1330 also adds an entry to the edits storage structure 1350 to specify that flow-based control 1314 is to be edited to flow-based control 1316 (based on the administrator's notification). This entry can be used by the update checker 1340 to globalize this edit to the other simulated display presentations of the application. Conjunctively or alternatively, the simulation modification tool 1330 notifies the update checker 1340 of any edits it makes so the update checker 1340 can globalize the edits.

At stage 1302, flow-based control 1314 has been edited by the simulation modification tool 1330 to flow-based control 1316, which is now displayed in the simulated display presentation 1310. At this stage, the update checker 1340 identifies, from the edits storage structure 1350, any edits that need to be made to any of the simulated display presentations of the application. In this example, the update checker 1340 identifies the edit to change flow-based control 1314 to flow-based control 1316, which the simulation modification tool 1330 has already done in the first display presentation 1310. After determining this, the update checker 1340 updates the flow-based control 1314 in the second simulated display presentation 1320 to flow-based control 1316.

At stage 1303, flow-based control 1314 in the second simulated display presentation 1320 has been edited by the update checker 1340 to flow-based control 1316. As such, the edit has been made to all of the necessary content of the simulated display presentations 1310 and 1320.

Similar to links, edits made to a simulated display presentation are also stored in a decoupled manner in some embodiments, which helps in preserving the edits even when the simulated display presentation's corresponding display presentation changes. Any elements that are edited are identified (e.g., using the above-described element detection algorithm), which makes the element robust to changes in simulated display presentation structure.

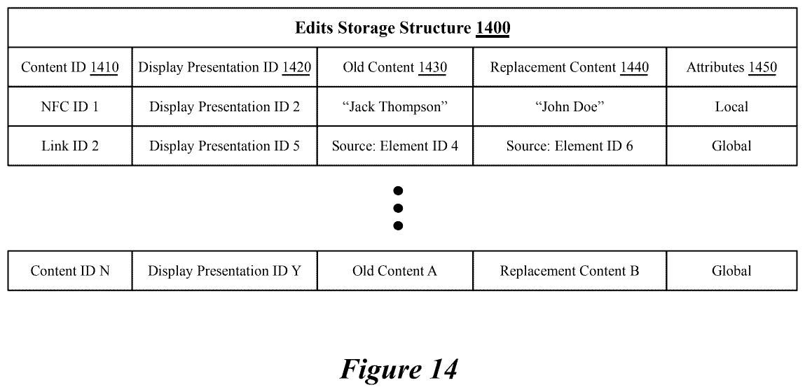

FIG. 14 illustrates an example edits storage structure 1400 (similar to the edits storage structures 1250 of FIG. 12 and 1350 of FIG. 13) that can be used to specify edits by an application administrator that are to be made to the application's simulation. The storage structure 1400 can be stored (e.g., as a table) in a data store for a simulation modification tool and update checker of a simulation updater. The edits storage structure 1400 is separate from stored display presentations (e.g., stored non-flow-based content and flow-based controls) in some embodiments such that the edits specified in the structure 1400 is applied only to simulated display presentations and not to stored display presentations. In this example, the storage structure 1400 specifies a content ID column 1410, a display presentation ID column 1420, an old content 1430 column, a replacement content column 1440, and an attributes column 1450.

For each edit made to the simulation of the application, the content column 1410 specifies a unique identifier associated with the content that is to be edited. For edits to non-flow-based content, this column 1410 specifies a non-flow-based content ID. For example, the storage structure 1400 includes an entry for non-flow-based content ID 1, meaning that there an administrator-specified edit to this non-flow-based content. For edits to flow-based content, such as flow-based controls, this column 1410 specifies a flow-based content ID. For example, the storage structure 1400 includes an entry for link ID 2, meaning that there is an administrator-specified edit to this link. For each edit, the display presentation ID column 1420 specifies the simulated display presentation on which the edit is to be made. For example, the edit to non-flow-based content 1 is to be made to display presentation 2.

For each edit, the old content column 1430 specifies the original content associated with the edit that is to be edited. For example, edit 1's old content specifies “Jack Thompson,” meaning that this edit is to change this particular name that is specified in non-flow-based content 1. As another example, edit 2's old content specifies element ID 4 as its source, meaning that link 2's original source element is to be changed.

For each edit, the replacement content column 1440 specifies the new content that is to be changed to the old content of the edit. For example, edit 1's replacement content specifies “John Doe,” meaning that this edit is to change “Jack Thompson” to “John Doe.” As another example, edit 2's replacement content specifies the element ID 6 as the link 2's new source, meaning that this link's source is to change from element 4 to element 6.

For each edit, the attributes column 1450 specifies whether the edit is to be a local or global edit. When an edit is a local edit, it is to be made only in a particular simulated display presentation specified by the administrator of the application and not any other simulated display presentations that also include the same content. For example, the edit to non-flow-based content 1 is a local edit, meaning that it is to be made only to the specified display presentation (i.e., display presentation 2, as specified in the column 1420). Even if non-flow-based content 1 is identified in any simulated display presentations other than simulated display presentation 2, this edit will not be made to those other simulated display presentations.

When an edit is a global edit, the edit is to be made to all sets of this content in all of the simulated display presentations. As such, a simulation updater examines all simulated display presentations, identifies any simulated display presentations that include the old content specified for this edit, and edits the old content into the specified replacement content in each of the identified simulated display presentations. For example, the edit to link 2 is a global edit, meaning that this edit is to be made to all simulated display presentations that include this link. While a global edit can be used to edit multiple simulated display presentations, it only has one entry in the data structure 1400 in some embodiments.

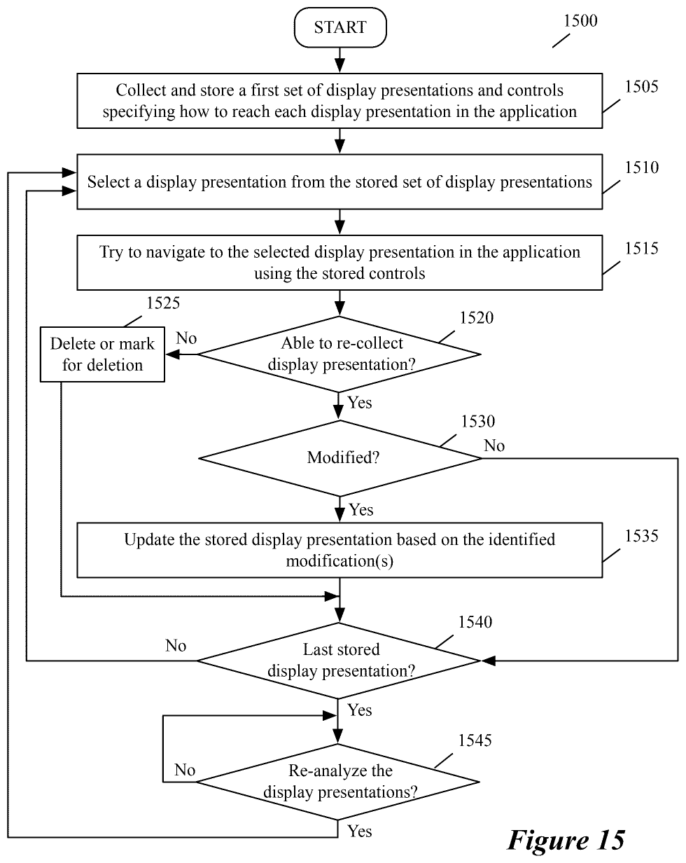

As discussed previously, some embodiments update non-flow-based content and/or flow-based controls collected and stored for display presentations of an application. These updates differ from the edits described in relation to FIGS. 12-14, as these updates are made to the display presentations of the actual application and not just the simulated display presentations generated to simulate the application. FIG. 15 conceptually illustrates a process 1500 of some embodiments for updating information of an application to use for its corresponding simulated application. This process 1500 is performed in some embodiments by a simulation updater that automatically updates any information stored that is associated with the application. The updated information can be used to generate simulated display presentations to provide simulated operations for the application.

The process 1500 begins by collecting (at 1505) and storing a first set of display presentations for the application and controls specifying how to reach each display presentation in the application. The simulation updater in some embodiments collects and stores the first set of display presentations by collecting and storing non-flow-based content and flow-based controls included in the display presentations of the application in a data storage. In some of these embodiments, the simulation updater creates a first set of one or more code copies that specifies the non-flow-based content and flow-based controls at the time the first code copy is collected. Each code copy in the first set can be collected and stored for each different display presentation of the application, such that each code copy is a different display presentation. The first set of code copies is a first HTML code copy in some embodiments, however, the first code copy can be in any suitable markup language.

The non-flow-based content of each display presentation includes one or more sets of data (e.g., text strings, images, etc.) for display in a set of one or more display areas (e.g., of a UI). These sets of data are not selectable in the display areas (unlike the flow-based controls), and can include any text, images, or any other non-selectable content of the application.

Each particular flow-based control is in some embodiments associated with at least one particular display presentation and is selectable to direct the application to transition to the particular display presentation. By selecting different flow-based controls, a user can step through different flows of the application.

In some embodiments, the data storage includes a first data store for storing the non-flow-based content and a second data store for storing the flow-based controls. In such embodiments, the non-flow-based content and flow-based controls are stored separately, as they are not linked to each other. For example, non-flow-based content does not specify any flow-based controls, and no flow-based controls include any non-flow-based content. While they are separately collected, however, some embodiments store both the non-flow-based content and the flow-based controls in a single data store (e.g., in different data structures of the same data store). In other embodiments, the non-flow-based content and the flow-based controls are stored in different data stores.

The simulation updater stores controls specifying how to reach each display presentation in the application in order to be able to navigate to each display presentation in the future. Then, the simulation updater can compare stored versions of the display presentations to their current versions to identify any modifications that have been made. In some embodiments, the stored controls for each display presentation include the URL and any cursor control operations (e.g., cursor selections, such as single or double clicks) needing to be made from the URL to reach the display presentation. For example, a first display presentation is in some embodiments reached using a particular URL and no cursor control operations (i.e., the display presentation can be navigated to using only the particular URL), and a second display presentation can be reached using the same particular URL and a set of cursor control operations (e.g., the second display presentation is the first display presentation but with an additional popup window or dropdown menu open that is shown when selected by a user). In this example, both display presentations are from a same page of the application (so they have the same URL), but they have a different subset of content, resulting in them being different display presentations. As such, both the URL and any cursor control operations are recorded in order to record the controls specifying how to reach each display presentation.

Conjunctively or alternatively, the simulation updater in some embodiments, for each display presentation, records and stores, for each display presentation, a display presentation ID that identifies the display presentation (e.g., an ID that is specified in the code copied for each display presentation, such as in the header tag of the code) as the control needed to reach the display presentation. Using these display presentation IDs, the simulation updater will be able to navigate to each display presentation in the application in the future.

Next, the process 1500 selects (at 1510) a display presentation from the stored first set of display presentations. The simulation updater selects a stored display presentation to determine any changes that have been made to the display presentations of the application. In some embodiments, the simulation updater selects the first stored display presentation of the application, which can correspond to a first page of the application. The simulation updater may instead select a display presentation non-deterministically. Any display presentation may be selected, and they may be selected in any order. Any suitable method used to navigate to a display presentation of an application can be recorded and stored.

At 1515, the process 1500 tries to navigate to the selected display presentation in the application using the stored controls. Using the controls specifying how to reach the selected display presentation (e.g., the recorded URL and cursor control operations (if any) needed to reach the display presentation in the actual application, the display presentation ID), the simulation updater tries to navigate to the current version of the selected display presentation in the application.

Then, the process 1500 determines (at 1520) whether the selected display presentation is able to be re-collected. The simulation updater in some embodiments does not successfully navigate to the selected display presentation at step 1515 (e.g., the stored URL is no longer a working URL, the cursor control operations no longer navigate to the display presentation, the display presentation ID is invalid, etc.). In some such embodiments, this is because the display presentation has been deleted from the application. If the process 1500 determines that the selected display presentation is unable to be re-collected (i.e., when the simulation fails to successfully navigate to the selected display presentation), the process 1500 deletes (at 1525) the selected display presentation from the data storage or marks the selected display presentation for deletion from the data storage. The simulation updater in some embodiments automatically deletes the selected display presentation from the data storage upon determining that it cannot navigate the current version of it in the application. The simulation updater may instead mark the selected display presentation in the data storage for deletion, and the administrator of the application can then approve its deletion, or the administrator can update this display presentation's navigation information so the simulation updater can correctly navigate to it.

When deleting the selected display presentation from the data storage, the simulation updater in some embodiments deletes the code copy stored for the display presentation. Conjunctively or alternatively, the simulation updater deletes the non-flow-based content and flow-based controls of the display presentation from the first and second data stores, as long as they are not part of any other display presentations of the application. If any of the non-flow-based content or any flow-based controls of the display presentation is included in any other display presentations, the simulation updater does not delete it (as it is needed for other display presentation(s)). After deleting the selected display presentation or marking it for deletion, the process 1500 proceeds to step 1540, which will be described below.

Alternatively to unsuccessfully navigating to the selected display presentation (and, therefore deleting it or marking it for deletion), the simulation updater in some embodiments, at step 1515, successfully navigates to the selected display presentation in the application. In such embodiments, the simulation updater is able to re-collect the selected display presentation, and does so by creating a new code copy that specifies the non-flow-based content and the flow-based content at the time this code copy is collected. This newly collected code copy is of the same language (e.g., HTML) as the previously stored code copy for the selected display presentation. If the process 1500 determines that the selected display presentation can be re-collected (and is re-collected), the process 1500 proceeds to step 1530.

At 1530, the process 1500 determines whether the re-collected version of the selected display presentation has been modified since the stored version of the selected display presentation was stored. The simulation updater compares these two versions of the selected display presentation to determine whether there have been any updates to it since it was last stored. In some embodiments, the simulation updater performs a hash calculation (e.g., on the newly collected code copy for the selected display presentation and a stored code copy for the previously stored version of the selected display presentation) to compare the re-collected display presentation to the previously stored display presentation. This hash calculation will identify any differences between the two display presentations, and the differences will indicate whether any modifications have been made. The simulation updater can identify any modifications made to non-flow-based content or any flow-based controls.

Conjunctively or alternatively, the simulation updater in some embodiments converts the previously stored code copy of the selected display presentation into a first image and the re-collected code copy of the selected display presentation into a second image. The simulation updater is then able to compare the first and second images to analyze them and identify any differences between the two images. A difference in the first image to the corresponding second image indicates that the display presentation has been modified.

If the process 1500 determines that one or more modifications have been made, the process 1500 updates (at 1535) the stored display presentation based on the identified modifications. In some embodiments, the simulation updater modifies the stored display presentation in the data storage by modifying a portion of data of this display presentation stored in the data storage without modifying any other data that has not been modified since the last collection. In such embodiments, the simulation updater only modifies the portion that has been changed since the last collection, and leaves the content that has not been modified.

In other embodiments, the simulation updater modifies the previously stored display presentation in the data storage by replacing it in the data storage with an updated version of this display presentation (i.e., the re-collected display presentation) that represents any modifications identified at 1530. In such embodiments, the simulation updater deletes the display presentation that was previously stored and stores the updated version collected at 1520.

In some embodiments, the simulation updater identifies a set of non-flow-based content that has been modified. For example, the simulation updater in some embodiments identifies that the text of non-flow-based content has been changed from the previously stored display presentation to the newly collected display presentation. In such embodiments, the simulation updater updates the set of non-flow-based content in the data storage.

Conjunctively or alternatively, the simulation updater identifies a flow-based control that has been modified. For example, the simulation updater in some embodiments identifies that the flow-based control's source selectable element, the appearance (e.g., font, color, location, size, etc.) of the flow-based control's selectable element, and/or the flow-based control's destination display presentation has been changed from the last version of the flow-based control currently stored in the data storage. In such embodiments, the simulation updater updates the flow-based control in the data storage to reflect the change(s). Any suitable change to non-flow-based content or a flow-based control can be identified by the simulation updater and updated in the data storage.

After updating the stored display presentation, the process 1500 determines (at 1540) whether the selected display presentation is the last stored display presentation. The simulation updater determines whether all stored display presentations have been selected for steps 1510-1535. If the process 1500 determines that the selected display presentation is not the last stored display presentation (i.e., that at least one stored display presentation has yet to be selected), the process 1500 returns to step 1510 to select another display presentation.

If the process 1500 determines that the selected display presentation is the last stored display presentation (i.e., that all stored display presentations have been selected), the process 1500 waits (at 1545) to re-analyze the display presentations of the application. In some embodiments, the simulation updater performs the process 1500 iteratively such that it is performed at specified intervals (e.g., every five minutes, every hour, every day, etc.). In such embodiments, the simulation updater waits until it is time to re-perform the steps 1510-1540 for the application. Once the application's display presentations are to be re-analyzed, the process 1500 returns to step 1510.

The simulation updater in some embodiments repeats the steps 1510-1545 iteratively, as the simulation updater performs the steps as part of an automated process that identifies modifications made to the display presentations. This automated process does not require any direct user input (i.e., input from the application administrator) regarding modifications to the display presentations. Conjunctively or alternatively, the simulation updater receives notification from the administrator of the application to stop performing the steps 1510-1545. In such embodiments, the simulation updater ends the process 1500 after receiving this notification from the administrator. The simulation updater may also or instead perform the steps 1510-1545 a particular number of times or for a particular period of time (e.g., as specified by the application's administrator or developer) before ending the process 1500.

The steps 1510-1545 are performed iteratively in some embodiments to automatically identify any modifications made to the application's display presentations. Iterative re-collection of display presentations to automatically modify them in storage is performed such that the administrator of the application does not have to manually notify the simulation updater of any modifications made to the application (i.e., to any display presentations of the application).

The simulation updater in some embodiments, after identifying modifications made to the display presentations, provides a specification of the modifications to the application's administrator. In such embodiments, the identified modifications are presented to the administrator (e.g., in a GUI, in a browser, etc.) for the administrator to review, test, and approve them. If the administrator approves the modifications, then the simulation updater modifies one or more display presentations based on the modifications. If the administrator does not approve the identified modifications, the simulation updater does not modify the stored display presentations.

The process 1500 is a process for checking for updates for previously collected display presentations of an application. this process 1500 can be performed periodically (e.g., every 24 hours, every week, etc.). Some embodiments perform a more robust application re-discovery or re-collection operation at a different rate than the process 1500 (e.g., less frequently, such as if process 1500 is performed daily or weekly the more robust process is performed bi-weekly or monthly). This robust process re-collects the entire application (e.g., which can be performed similarly to step 1505 of the process 1500), which will identify already-stored display presentations that are still included in the application, as well as discover any new display presentations of the application. If a new display presentation is discovered during the robust process, the simulation updater collects and stores the new display presentation (i.e., its non-flow-based content and flow-based controls) along with the other stored display presentations of the application.

The display presentations stored in the data storage are in some embodiments used to provide the simulated operations of the application by generating simulated display presentations to simulate the application. These simulated display presentations, when interacted with in a UI (e.g., a GUI) by a user, will simulate the operations of the application. The user can then use the simulated display presentations to learn how to use the application without actually accessing the application.

Some embodiments make updates to display presentations (e.g., to non-flow-based content and/or flow-based controls) after simulated display presentations have been generated. In some of these embodiments, at least one of the already generated simulated display presentations had one or more administrator-defined edits. For example, the simulation updater in some embodiments receives direction from an administrator the application to edit a first set of content in a first simulated display presentation to a second set of content. In such embodiments, while the collected display presentation along with the display presentation associated with the first simulated display presentation will continue to include the first set of content, the first simulated display presentation will be edited. As such, the application simulator edits the first set of content in the first simulated display presentation to the second set of content, and stores a particular entry in a data structure identifying a set of one or more edits to be made to the simulated display presentations. The particular entry specifies that the first set of content is to be edited to the second set of content in at least the first simulated display presentation.

Then, the simulation updater in some embodiments identifies an update to non-flow-based content and/or flow-based control(s) used in generating the simulated display presentation. As such, the simulation updater generates a second simulated display presentation to replace the first simulated display presentation. This second simulated display presentation reflects the updates to the non-flow-based content and/or flow-based control(s). Then, the simulation updater compares the set of edits stored in the data structure to the second simulated display presentation to determine whether any edits need to be made to the second simulated display presentation. As each simulated display presentation is generated, the simulation updater compares the set of edits in the data structure to the simulated display presentation to ensure that each edit is properly applied to all of the simulated display presentations generated for the application.

The simulation updater identifies the first set of content in the second simulated display presentation. Then, after matching the first set of content in the second simulated display presentation to the particular entry stored in the data structure, the simulation updater edits the first set of content to the second set of content in the second simulated display presentation. Now, the second simulated display presentation includes both updates made to the application and the edit received from the application administrator.

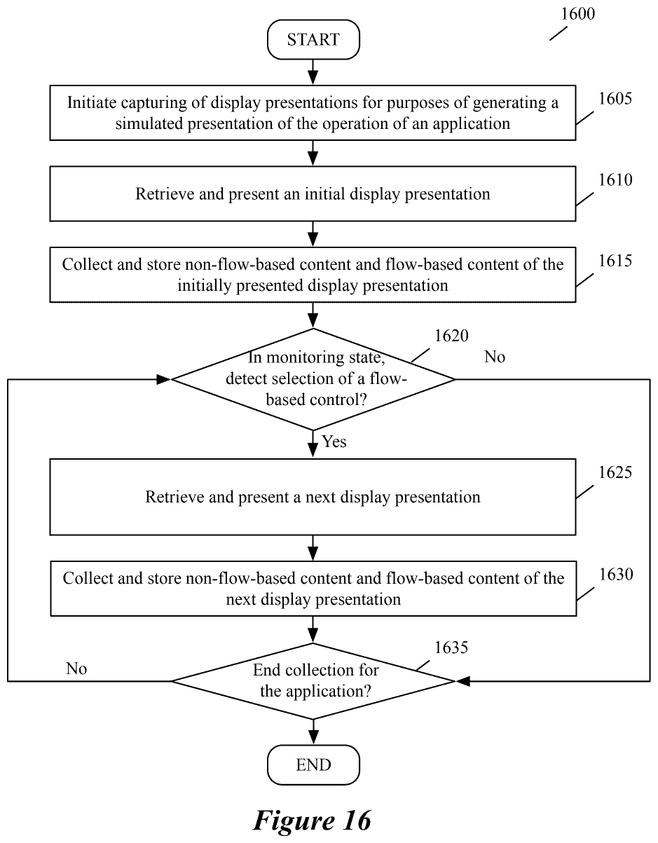

As discussed previously, some embodiments collect non-flow-based content and flow-based content (e.g., flow-based controls) of an application to use to generate a simulation of the application. In some of these embodiments, a simulation generator does not have access to the source code of the application. As such, the application uses a recording method to collect the content of the application to use to generate the simulation. FIG. 16 conceptually illustrates a process 1600 of some embodiments for collecting content of an application without access to the application's source code. This process 1600 is performed in some embodiments by a simulation generator of an application simulation system (such as the simulation generator 100 of FIG. 1).

The process 1600 begins by initiating (at 1605) capturing of display presentations for purposes of generating a simulated presentation of the operation of the application. The simulator generator in some embodiments receives notification that the application administrator has initiated the recording of their application in their browser via a browser extension for the simulation generator. In some of these embodiments, this notification is received from a data capture module executing within the browser extension. In other embodiments, the simulation generator receives this notification as an API call from the administrator to notify the simulation generator that the recording of the application has started.

Next, the process 1600 retrieves (at 1610) and presents an initial display presentation. After the initial capturing of the display presentations, the simulation generator in some embodiments retrieves an initial display presentation of the application and presents it to the administrator. The initial display presentation can be presented in the administrator's browser.

At 1615, the process 1600 collects and stores a first set of non-flow-based content and flow-based content of the initially presented display presentation. After the recording has been started by the administrator, the simulation generator examines the initial display presentation to collect the content of the initial display presentation that is shown for the application. In some embodiments, this is a home page of the application. The simulation generator collects all non-flow-based content and flow-based content (e.g., flow-based controls, elements) for this display presentation and stores it in a set of one or more data stores. For example, the simulation generator in some embodiments stores the non-flow-based content in a first data store and the flow-based content in a second data store. As another example, the non-flow-based content and flow-based content are in some embodiments stored in a same data store (e.g., in separate tables in the data store).

In some embodiments, the simulation generator collects and stores the non-flow-based content and flow-based content by (1) identifying, from a first set of code for the initial display presentation, the first set of non-flow-based content and the first set of flow-based controls, and (2) copying the first set of non-flow-based content and the first set of flow-based controls from the first set of code. The simulation generator examines the code set in order to collect the first sets of non-flow-based content and flow-based controls. This first set of code is in some embodiments an HTML code (e.g., when the application is a web application). In other embodiments, the first set of code and the application is described in another language. Still, in other embodiments, the first set of code and the application is described in another language that is not a markup language, but is a custom-defined language for the application. The application may also not be a web application.

The simulation generator in some embodiments stores, for all non-flow-based content collected, an ID identifying the non-flow-based content and data (e.g., a text string, an image, video, audio) for the non-flow-based content. In such embodiments, the data is non-selectable content included in one or more display presentations, and is, therefore, non-flow-based content. The simulation generator stores, for each collected flow-based control, a first ID identifying the flow-based control, a second ID identifying a source selectable element of the flow-based control, and a third ID identifying a destination display presentation of the flow-based control. This allows the simulation generator to know which display presentation is to be displayed upon selection of each selectable element of the application.

For each flow-based control, the simulation generator in some embodiments also stores a specification of the flow-based control that indicates whether the flow-based control is a local flow-based control or a global flow-based control. Each local flow-based control is applied on only one display presentation. For example, an administrator in some embodiments specifies, to the simulation generator, that a particular flow-based control is a local flow-based control. The administrator may also specify on which display presentation it is located. As such, the simulation generator will not apply this flow-based control on any other display presentations, even if the same selectable element is identified in other display presentations. These would be treated as different selectable elements. In some of these embodiments, the simulation generator does include the source display presentation of each local flow-based control in the second data store.

Each global flow-based control is applied on each display presentation that includes the source selectable element of the global flow-based control. For example, an administrator in some embodiments specifies, to the simulation generator, that a particular flow-based control is a global flow-based control. As such, each time the selectable element associated with the global flow-based control is identified in a display presentation, the simulation generator knows that it is the particular flow-based control. Each global flow-based control is in some embodiments stored only once in its data store. This is done in some embodiments to save space in the data store, and because only one entry is needed (as the source display presentations for global flow-based controls are not specified).

Then, in a monitoring state, the process 1600 determines (at 1620) whether a selection of a flow-based control has been detected. The simulation generator in some embodiments is able to detect selections of flow-based controls in currently displayed display presentations. For example, the simulation generator in some embodiments is able to detect when the administrator selects, via a cursor control operation, one of the flow-based controls.

In this monitoring state, the simulation generator determines whether it has detected a selection of any flow-based control included in the currently displayed display presentation. This detection is performed by detecting whether a selection (e.g., a cursor control operation, such as a cursor selection using a click or double click) of a selectable element corresponding to a flow-based control has been selected. In such embodiments, each flow-based control is specified with a selectable element as its source and a display presentation as its destination. If the process 1600 determines that a selection of a flow-based control has not been detected, the process 1600 proceeds to step 1635, which will be described below.

If the process 1600 determines that a selection of a flow-based control has been detected, the process 1600 retrieves (at 1625) and presents a next display presentation. Upon the detection of the flow-based control selection, the simulation generator in some embodiments retrieves the next display presentation corresponding to the selected flow-based control and presents it to the administrator.

Then, the process 1600 collects (at 1630) and stores non-flow-based content and flow-based content of the next display presentation. After the next display presentation is presented to the administrator, the simulation generator can collect and store its content. This new display presentation can be a completely new page of the application or it can be the same page with a popup window or dropdown menu. Any visual change to an application is treated as a new display presentation.

When the next display presentation is presented in the administrator's browser, the simulation generator examines the next display presentation to collect the non-flow-based content and flow-based content (e.g., flow-based controls, elements) for this next display presentation and store it in the set of one or more data stores. In some embodiments, the simulation generator examines the next display presentation by (1) identifying, from a second set of code for the next display presentation, the second set of non-flow-based content and the second set of flow-based controls, and (2) copying the second set of non-flow-based content and the second set of flow-based controls from the second set of code. The second set of code is in the same language (e.g., HTML) as the first code set.

At 1635, the process 1600 determines whether to end collection for the application or to continue the collection. The simulation generator in some embodiments determines whether it has received notification that the administrator wishes to end the recording of the application. In some of these embodiment, the simulation generator examines the administrator's browser to determine whether the recording has ended. Conjunctively or alternatively, the simulation generator determines whether it has received a notification from the data capture module of a browser extension or from the administrator as an API to end the recording.

If the process 1600 determines that collection for the application has not ended, the process 1600 returns to its monitoring state (at 1620) and determines whether selection of a flow-based control is detected. If the process 1600 determines that collection for the application has ended, the process 1600 ends. When the administrator ends the recording, the simulation generator stops its collection of content for the application. Once collection for the application is completed, simulated display presentations can be generated using the stored non-flow-based content and flow-based content.

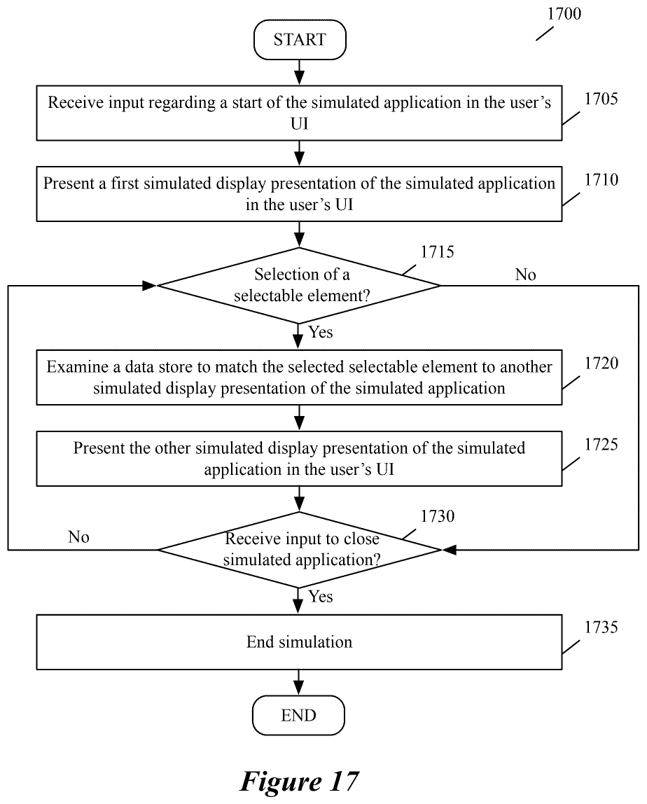

As discussed previously, once a simulated application is created for an application, it can be accessed by one or more users so the users can train on the use of the application without actually using the application. FIG. 17 conceptually illustrates a process 1700 of some embodiments for presenting a simulated application to a user. The process 1700 is performed in some embodiments by a simulation player of an application simulation system that created the simulated application from an application. The user is presented the simulated application in some embodiments for the user to learn how to use the application (e.g., to train the user to know how to use the application) without allowing the user to access the application. In some embodiments, each display presentation of the simulated application is pre-rendered before the process 1700 begins.

The process 1700 begins by receiving (at 1705) input regarding a start of the simulated application in the user's UI. The simulation player of some embodiments receives this input by receiving a notification from a user. This notification is received through the user's UI as the user is launching the simulated application (e.g., in a user device's browser). In some embodiments, the notification first received at a client-side renderer of the simulation player that operates in the user's UI (e.g., as a browser extension). In such embodiments, the client-side renderer receives the notification and provides it to an application simulator server. In other embodiments, the notification is received directly at the application simulator server (e.g., at a simulation player of the application simulator server).

In some embodiments, the input is received along with a set of login credentials (e.g., a username and password). In such embodiments, the simulated application is only allowed to be used by authorized users that have a set of login credentials known by the simulation player. The simulation player in such embodiments receives the user's set of login credentials and authenticates the set of login credentials to allow access to the simulated application.

Next, the process 1700 presents (at 1710) a first simulated display presentation of the simulated application in the user's UI. After receiving notification to initiate the simulated application, the simulation player retrieves the first simulated display presentation in order to present it in the user's UI. The first simulated display presentation can correspond to a first display presentation of the application, such as a home page or a dashboard page. The first simulated display presentation is presented to the user in the user's UI to simulate the first display presentation of the application to the user.

In some embodiments, the simulated display presentations of the simulated application are stored by the simulation player in a hierarchical structure, such as a JavaScript object notation (JSON) tree structure. This hierarchical structure allows the simulation player to know which simulated display presentation is the first simulated display presentation of the simulated application. The first simulated display presentation is presented in the user's UI in some embodiments, as the first simulated display presentation is stored by the simulation player in a JSON format. This JSON format is converted to a script language (e.g., JavaScript), and presented in the UI.

At 1715, the process 1700 determines whether a selection of a selectable element has been detected. The simulation player determines whether any selectable elements in the currently presented simulated display presentation have been selected (e.g., with a cursor control operation) by the user. For example, the simulation player in some embodiments determines whether the user selects a selectable element with a cursor control operation. If the process 1700 determines that a selection of a selectable element has not been detected, the process 1700 proceeds to step 1730, which will be described below.

If the process 1700 determines that a selection of a selectable element has been detected, the process 1700 examines (at 1720) a data store to match the selected selectable element to another simulated display presentation of the simulated application. The simulation player of some embodiments stores, in a data store, information regarding different simulated display presentations, elements, and links for the simulated application. Using the data store, the simulation player can determine which link is associated with the selected element, and which simulated display presentation is associated with the determined link. For example, the simulation player in some embodiments identifies the selected element, identifies the element ID for the selected element, and performs a lookup operation in the data store to identify a link corresponding to the element ID. Then, the simulation player identifies a destination simulated display presentation corresponding to the identified link, which is the simulated display presentation that is to be shown to the user upon selection of the selected element.

After matching the selected selectable element to the other simulated display presentation, the process 1700 presents (at 1725) the other simulated display presentation of the simulated application in the user's UI. The simulation player replaces the previously displayed simulated display presentation in the UI (e.g., in a display area of the UI) with the new simulated display presentation. This new simulated display presentation is shown to the user in the UI to simulate what would be shown to the user if the user were to select the selected element in the actual application.

At 1730, the process 1700 determines whether input to close the simulated application has been received. In some embodiments, this input is received as a notification from the user when they wish to end this session of using the simulated application. If the process 1700 determines that this input has not been received, the process 1700 returns to step 1715 to again determine whether a selection of a selectable element has been detected.

If the process 1700 determines that an input to close the simulated application has been received, the process 1700 closes (at 1735) the simulated application in the user's UI. The simulation player, after receiving this input, knows that the user wishes to end their session of using the simulated application. As such, the simulation player (e.g., the client-side renderer of the simulation player) removes the currently presented simulated display presentation from the user's UI and closes the simulated application on the user's UI. After closing the simulated application, the process 1700 ends.

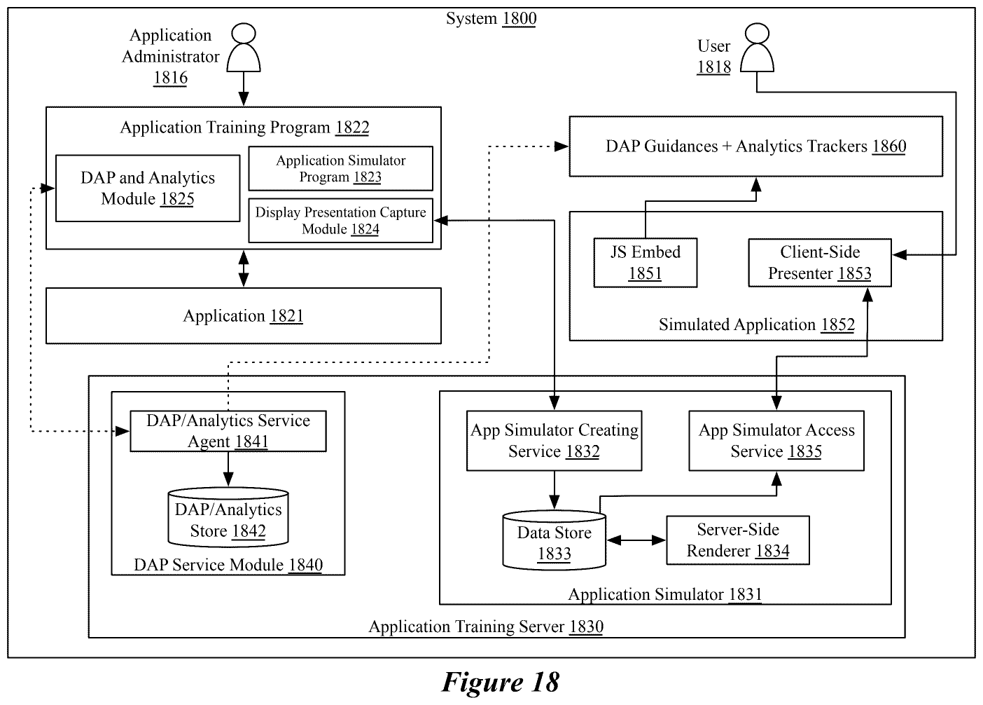

The above-described embodiments describe an application simulation system that generates and maintains a simulation created to provide simulated operations of one or more applications. FIG. 18 illustrates a more specific example of a system 1800 that performs some embodiments of the invention to generate and provide simulated application 1852 to a user 1818. The system 1800 includes various components to generate a simulated application 1852 based on an application 1821, and present the simulated application 1852 to a user 1818 for the user 1818 to train on how to use the application 1821 without accessing the application 1821. The system 1800 includes an application 1821, an application training program 1822, an application training server 1830, a simulated application 1852, and a DAP guidance and analytics tracker 1860.

In some embodiments, the application 1821 is a web application. In such embodiments, the application administrator 1816 accesses the application 1821 through a browser (similar to the browser 710 of FIG. 7) using, e.g., a URL. The application training program 1822 can also be accessed through a browser (e.g., as a browser extension). In some of these embodiments, the simulated application 1852 is accessed by the user 1818 also through a browser.

The application training program 1822 includes an application simulator program 1823, a display presentation capture module 1824, and a DAP and analytics module 1825. The application training server 1830 includes (1) a DAP service module 1840 with a DAP and analytics service agent 1841 and a DAP and analytics data store 1842, and (2) an application simulator 1831 with an application simulator creating service 1832, a data store 1833, a server-side renderer (SSR) 1834, and an application simulator access service 1835.

The application simulator 1831 along with the application simulator program 1823 and display presentation capture module 1824 generate the simulated application 1852 to be accessed and used by the user 1818. The DAP service module 1840 along with the DAP and analytics module 1825 generate the DAP guidance and analytics tracker module 1860 to execute alongside the simulated application 1852 to provide guided training through the simulated application 1852 for the user 1818.

The application simulator 1831 can be used standalone by the administrator 1816 such that the simulated application 1852 is a self-learning training playground, but use of the application simulator 1831 along with the DAP service module 1840 provides structured training modules for the simulated application 1852. The application simulator 1831 can also internally use product analytics capabilities to capture the progress of the user 1818 using the simulated application 1852.

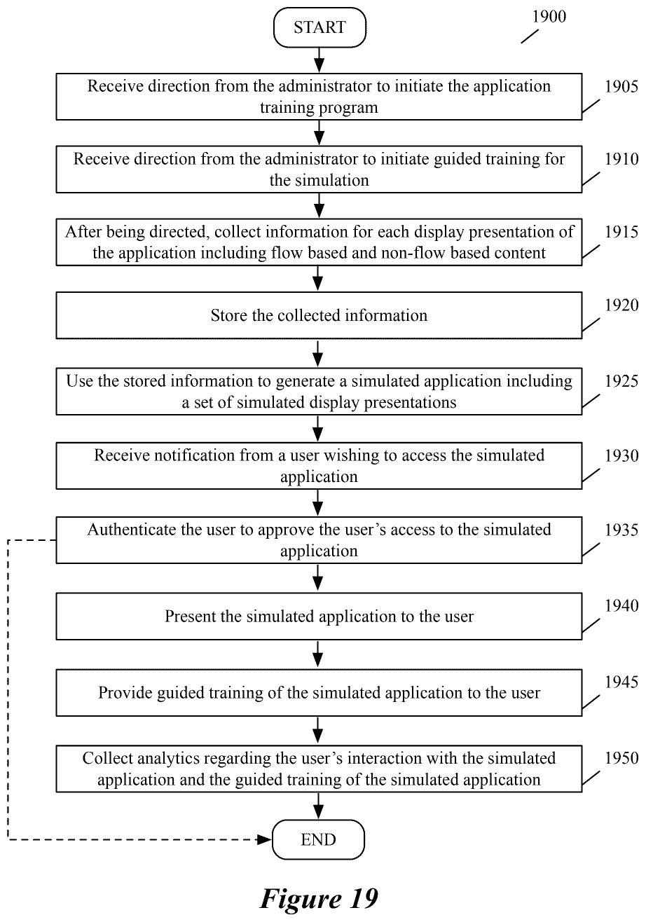

The operation of the system 1800 will now be further described by reference to FIG. 19, which conceptually illustrates a process 1900 of some embodiments for creating and using a simulation of an application. In some embodiments, the process 1900 begins when the process 1900 receives (at 1905) direction from an administrator of the application to initiate the application training program. The application simulator program 1823 of the system 1800 receives notification from the administrator 1816 that they wish to access the application training program 1822. The administrator 1816 may access the application training program 1822 to create the simulated application 1852 and/or to create the DAP guidance and analytics tracker 1860. To do this, the administrator 1816 in some embodiments launches the application 1821 (e.g., in a browser) and invokes the application training program 1822 (e.g., as a browser extension from a browser menu).

In some embodiments, the application training program 1822 allows the administrator 1816 to create overlay components (e.g., one or more DAP guidance and analytics modules 1825, the application simulator program 1823, the display presentation capture module 1824). In such embodiments, the application training program 1822 displays, in the administrator's browser, an overlay on top of the presentation of the application 1821. In this overlay, the application administrator 1816 is able to select what kind of content they want to create. For example, the administrator 1816 can create the DAP guidance or an analytics tracker (i.e., the DAP and analytics module 1825), or a display presentation capture module 1824. If the administrator 1816 creates DAP or analytics content, it is stored in the DAP and analytics data store 1842.

Next, the process 1900 receives (at 1910) direction from the administrator to initiate guided training. The DAP and analytics module 1825 in some embodiments is initiated in the application training program 1822 to begin processes to create guided training for the application 1821. In such embodiments, the DAP and analytics module 1825 creates one or more training display presentations that will be used to guide the user 1818 through the workflows of the simulated application 1852 (which are the same workflows of the application 1821). These training display presentations are presented to the user using the DAP guidance and analytics tracker 1860. As the DAP and analytics module 1825 creates the training display presentations, it provides them to the DAP and analytics service agent 1841 of the DAP service module 1840 to store in the data store 1842.

After being directed, the process 1900 collects (at 1915) information for each display presentation of the application including flow-based content and non-flow-based content. Using the application training program 1822, the administrator 1816 invokes the application simulator program 1823 and the display presentation capture module 1824. In some embodiments, the administrator 1816 does do by pressing a “record” selectable item of the application simulator program 1823. The start of this recording notifies the application simulator program 1823 that creation of the simulated application 1852 is to begin. In other embodiments, the application simulator program 1823 includes a different selectable item that the administrator 1816 initiates to initiate collection of the application's information (which, in turn, initiates the creation of the simulated application 1852).

The display presentation capture module 1824 is activated to collect information at the start of the recording and at each time a mouse click is detected for the application 1821. At each of these times, the display presentation capture module 1824 captures flow-based content (e.g., by capturing flow-based controls and elements) and non-flow-based content (e.g., by capturing snapshots, such as HTML snapshots) of a display presentation of the application 1821 currently displayed to the administrator 1816. The display presentation capture module 1824 may collect this information by performing operations similar to the process 1600 of FIG. 16. In some embodiments, an HTML document object model (DOM) structure is captured at these times and saved in the application simulator 1831.

More specifically, when the record button is pressed, the capture module 1824 captures the display presentation of the application 1821 currently displayed to the administrator 1816. Each time the administrator 1816 selects (e.g., clicks on) any selectable elements of the application 1821 during the recording, the capture module 1824 captures the properties of the selected element in the current display presentation and also captures the new display presentation of the application 1821 that is displayed after the selection.

In some embodiments, the capture module 1824 identifies an outgoing link from the selected element on the current display presentation to the new display presentation (e.g., Display Presentation 1: Element 1→Display Presentation 2). When the administrator 1816 selects a selectable item that causes a dropdown menu to be displayed, this is considered to be a new display presentation. When the application is a web-based application, one application page can result in any number of captured display presentations.

To capture a display presentation, the capture module 1824 in some embodiments traverses through a DOM structure of the application 1821 and specifically identifies the elements included in the display presentation. In some of these embodiments, <script> and <base> elements of the display presentation's code are ignored. The <iframe> elements of the code are in some embodiments stored separately from the display presentations, and a link to these separate iframes is created from the current display presentation using a newly generated URL. Same-domain iframes, cross-domain iframes, and no-source iframes are also handled in a specific manner.

For instance, some embodiments access the HTML structure of same-domain and no-source iframes from the parent window. For cross-domain iframes, some embodiments do not allow a browser running in a parent window to access the HTML structure of the iframe, due to security restrictions. In such embodiments, only a JavaScript running inside the iframe will have access to the HTML structure of the iframe. To capture these types of iframes, the capture module 1824 in some embodiments first injects a capture script in the top window and all of the iframes at all levels. When a display presentation is to be captured, the capture module 1824 posts a message to the top window to capture the display presentation. On receiving a capture message, the JS (1) posts a message to each iframe in the HTML code to capture its content, (2) captures the HTML structure of the current window, and (3) waits for all of the child iframes to complete (which is done recursively by all of the iframes).

For example, a page structure in some embodiments includes frame 1, frame 1.1, frame 1.2, frame 2, frame 2.1, frame 2.1.1, and frame 3. For this page structure, capture messages are posted to frames 1, 2, and 3. Frame 1 posts messages to frame 1.1 and 1.2. Frame 1 also captures its own direct HTML elements and waits for frames 1.1 and 1.2 to complete (which each captures its own direct elements). Frame 2 posts messages to frame 2.1, captures its own direct HTML elements, and waits for frame 2.1 to complete. Frame 2.1 posts messages to frame 2.1.1, captures its own direct elements, and waits for frame 2.1.1 to capture its direct HTML elements. Frame 3 captures its own direct HTML elements.

Each display presentation captured by the capture module 1824 is provided to the application simulator creating service 1832 to store in the data store 1833. In some embodiments, the HTML DOM structure (also referred to as a DOM hierarchy) of the application 1821 is also captured by the capture module 1824.

Resource elements (e.g., image, CSS) are downloaded by the capture module 1824 from the application 1821 and provided to the application training server 1830 (i.e., to the application simulator creating service 1832) to store in the data store 1833. The original URLs of these resource elements are adapted in the application simulator 1831 (e.g., by the SSR 1834) to point to the simulated versions of the resources. To ensure one resource URL is stored only once to the data store 1833, the application simulator creating service 1832 in some embodiments checks whether a specification of a resource, received from the capture module 1824, is already stored in the data store 1833 before storing the specification of the resource.

In some embodiments, one or more resources are each included in multiple display presentations of the application 1821. To reduce download and upload time, the capture module 1824 first checks with the application simulator creating service 1832 if a resource is already stored in the data store 1833. If it is not, the capture module 1824 initiates the download and upload of the resource. This check with the application simulator creating service 1832 is done in bulk in some embodiments to optimize the level of traffic between the capture module 1824 and the application training server 1830. The check is also in some embodiments cached in the administrator's machine (not shown) to further optimize it. For the rest of the elements, all attributes of the elements are captured and stored in the data store 1833 (such as any of the element attributes described in FIG. 11).

To capture a link of the application 1821, the source element on the current display presentation on which the administrator 1816 selects is identified as the source location of the link, and the destination display presentation is identified as the destination of the link. In some embodiments, the element is identified by the capture module 1824 by identifying a set of parameters associated with the element using an element detection algorithm. This algorithm captures one or more parameters of the element (e.g., element ID, inner text, class) and its adjacent elements. The algorithm also stores the attributes of any other elements within the display presentation and the relative structural position of the element, and is aware of popular base applications and the reliable attributes of those applications. This element detection algorithm also helps in identifying the same element even if a display presentation is recaptured and its structure is changed.

At 1920, the process 1900 stores (at 1920) the collected information. As the capture module 1824 collects the flow-based content and non-flow-based content, it provides this data to the application simulator creating service 1832 to store in the data store 1833. While only one data store 1833 is illustrated, some embodiments use different stores to store the flow-based content and non-flow-based content separately.

Captured elements are in some embodiments stored in a tree structure in JSON format and transferred to the application simulator 1831 where it is stored in the data store 1833 in JSON format. In some of these embodiments, the top window of the tree structure includes a set of one or more iframes. Each of the iframes can each include a set of one or more iframes inside of it. All of these iframes are recursively captured and stored in the data store 1833. The top window of the tree structure in some embodiments waits for all of its child iframes to complete and adapts its iframe URL before storing its data in the data store 1833.

If a display presentation includes one or more iframes, the DOM hierarchy of the display presentation is stored as well. Using the example described above of frames 1, 1.1, 1.2, 2, 2.1, 2.1.1, and 3, the DOM hierarchy of these frames is stored to specify (1) frame 1 has child frames 1.1 and 1.2, (2) frame 2 has child frame 2.1, (3) frame 2.1 has its own child frame 2.1.1, and (4) frame 3 has no child frames.

Information for links and edits, including their attributes (such as the attributes described in FIGS. 11 and 14), are stored separately from the display presentation DOM hierarchy in the data store 1833. For example, for links, the destination display presentation ID is stored, and for edits, the replacement content (e.g., replacement text) is stored. For both links and edits, an indication of whether the link or edit is global or local is stored. Global elements are searched for in all display presentations. Local elements are applied only on the display presentation specified by the administrator 1816 or the first display presentation on which the element was identified.

Next, the process 1900 uses (at 1925) the stored information to generate a simulated application including a set of one or more simulated display presentations. Once the flow-based content and non-flow-based content are stored in the data store 1833, the SSR 1834 uses it to generate the set of simulated display presentations. For example, the SSR 1834 in some embodiments performs the operations of the simulation pre-renderer 900 of FIG. 9 to generate the simulated display presentations. Using snapshots that specify the non-flow-based content, the SSR 1834 maps the flow-based content to their location(s) in each display presentation of the application. 1821. Then, the SSR 1834 is able to render the simulated display presentations, which are replicas of the actual display presentations of the application 1821.

In some embodiments, after the SSR 1834 creates the set of simulated display presentations, the SSR 1834 generates a simulated application URL for users (e.g., the user 1818) to access the simulated application 1852. In such embodiments, the SSR 1834 provides the simulated application URL through the application simulator creating service 1832 to the application simulator program 1823, which provides it to the administrator 1816. Conjunctively or alternatively, the SSR 1834 provides the simulated application URL to the administrator 1816 as a communications notification, such as an email or other communications means. After receiving the simulated application URL, the administrator 1816 can then provide it to any users they wish to access the simulated application 1852 (such as the user 1818).

Rather than using a URL to access the simulated application 1852, some embodiments use a learning management system (LMS). In such embodiments, SSR 1834 creates a sharable content object reference package (SCORM) package, which is uploaded to the LMS system and the user 1818 accesses the simulated application 1852 from their LMS course.

In some embodiments, the simulated display presentations include one or more global links and/or global edits that are to be applied across all other display presentations. This can be due to the application having hundreds of links and edits, with a subset of them being applicable in a single display presentation. Computing all of these links and edits when the simulated application 1852 is generated is time consuming and can lead to poor user experience for the user 1818. As such, the SSR 1834 pre-computes (i.e., pre-renders) all links and edits that are applicable to multiple display presentations and keeps them ready for displaying the simulated application 1852 to the user 1818. When one of these simulated display presentations is presented, the application simulator access service 1835 simply has to return the pre-computed simulated display presentations.

As the SSR 1834 is generating the simulated application 1852 or after the SSR 1834 has finished generating the simulated application 1852, the SSR 1834 is in some embodiments is notified on changes in display presentation or link information (e.g., add, modify, delete, etc.). Upon receiving notification of a change, the SSR 1834 regenerates the necessary simulated display presentation(s) to be used for the simulated application 1852.

When an updated display presentation is captured by the capture module 1824, any links and/or edits that were previously created for that display presentation does not have to be recaptured. In such embodiments, the application simulator creating service 1832 stores the information in the data store 1833 and notifies the SSR 1834 of the changes in the display presentation or link information. The SSR 1834 runs asynchronously so that the administrator 1816 does not have to wait while the simulated application 1852 is being prepared by the SSR 1834. Edits and links are both referred to as transformations, in some embodiments, as they apply a specific change (either adding a link or changing text or an image) to an element in a display presentation.

When the SSR 1834 receives an asynchronous message, the SSR 1834 examines the data store 1833 for all pending updates. Based on the pending updates it identifies, the SSR 1834 finds the list of display presentations for which new simulated display presentations need to be regenerated. For example, the administrator 1816 is provided, through a user interface, options to perform operations such as to capture display presentations, delete display presentations, create flow-based controls in display presentations, and modify sources and/or destinations of flow-based controls for use in the simulated application 1852. The administrator 1816 is also provided with options to record a sequence of operations. When the application training server 1830 receives calls from the administrator 1816 to perform any of the operations, it creates the necessary entries in the data store 1833 and posts the appropriate messages to the SSR 1834.

In some embodiments, these messages to the SSR 1834 are posted to a queue, and each message includes a display presentation ID of the display presentation for which the operation is to be performed (e.g., the display presentation to capture, delete, modify, etc.). The SSR 1834 reads all currently available messages in the queue, finds a unique list of display presentation IDs, and runs the display presentation capturing process (i.e., with the capture module 1824) for the listed display presentation IDs. In some embodiments, the SSR 1834 iteratively reads the messages stored in the queue to run the capturing process for the listed display presentations.

The SSR 1834 in some embodiments includes a set of SSR instances, such that each SSR instance reads the queue to process a different set of messages. In some of these embodiments, each SSR instance is assigned to process messages specifying a different set of display presentation IDs, such that one SSR instance processes all messages for each given display presentation ID, and such that no two SSR instances process the same message.

For each display presentation for which the SSR 1834 is creating a new simulated display presentation, the SSR 1834 performs its processing, as further described below. In some embodiments, different display presentations are processed in parallel, and once the processing is complete, the SSR 1834 marks the updates as completed.

As the SSR 1834 consolidates all currently available updates and performs its processing in batches, it reduces the number of times a simulated display presentation has to be regenerated (e.g., if the administrator 1816 is making many small updates). In such embodiments, when the SSR 1834 is busy processing one set of updates, messages for newer updates are accumulated in a queue. After the SSR 1834 completes the current processing of the set of updates, it consumes all pending messages waiting in the queue and initiates one bulk operation for processing these new pending updates.

For each display presentation, the SSR 1834 in some embodiments runs a headless browser in the background of the application simulator 1831 to load the corresponding simulated display presentation. In such embodiments, the SSR 1834 then runs through all display-presentation-specific and global transformations stored in the data store 1833. For each transformation, the display presentation's associated element's attributes are search in the loaded simulated display presentation. Any elements may be found, however, in some embodiments, none of the elements are found. For each element found in the simulated display presentation, the SSR 1834 stores a metadata of the transformation to be applied along with the element. The SSR 1834 does not store the complete simulated display presentation in such embodiments but stores the DOM hierarchy in a tree format in JSON.

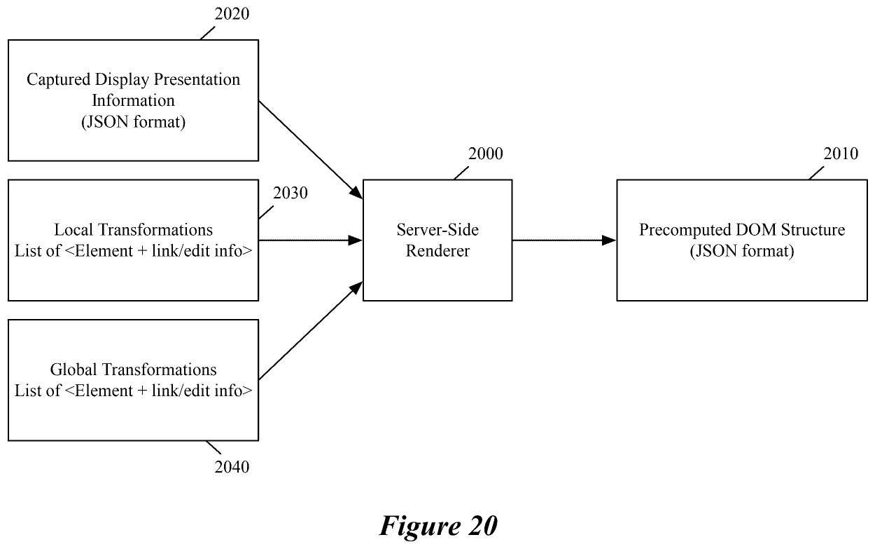

FIG. 20 illustrates an example SSR 2000 that creates a pre-computed DOM structure 2010 in JSON format. The SR 2000 uses captured display presentation information 2020 in JSON format, local transformations 2030 (including a list of local elements and their link and edit information), and global transformations 2040 (including a list of global elements and their link and edit information) to pre-compute the DOM structure 2010 for the display presentations in JSON format.

Referring back to FIG. 19, at 1930, the process 1900 receives notification from a user wishing to access the simulated application. The client-side presenter 1853 of the simulated application 1852 receives, from the user 1818, a notification to present the simulated application 1852 to the user 1818 (e.g., in a browser). In some embodiments, this notification is received when the user 1818 inputs the simulated application URL (which the user 1818 received from the administrator 1816) into a browser. The notification in some embodiments also includes a set of credentials so the user 1818 can be authenticated before accessing the simulated application 1852.

Then, the process 1900 authenticates (at 1935) the user to approve the user's access to the simulated application. In some embodiments different levels of security are provided for accessing the simulated application 1852. In an open access, the simulated application 1852 is not secured and anyone having access to the simulated application URL may access the simulated application 1852. The simulated application URL generated to access the simulated application 1852 in such embodiments includes dynamically generated IDs such that it is not easy to guess the URL unless one receives the URL. For open access, the simulated application access service 1835 does not need to authenticate any credentials received from the user 1818, as the user 1818 used the application simulation URL to request access to the simulated application 1852.

Timed access is similar to open access, but access to the simulated application URL in such embodiments has a deactivation date or is deactivated manually (e.g., by the administrator 1816). This is used in some embodiments when the simulated application 1852 is to be shared to specific users (e.g., user 1818) for a small duration of time. In such embodiments, the application simulator access service 1835 allows the user 1818 to access the simulated application 1852, but only for a particular period of time associated with the simulated application URL input by the user 1818 to request the access.

In single-sign-on (SSO) integration, the simulated application 1852 is configured to use a user's set of SSO credentials. In such embodiments, when the client-side presenter 1853 receives the notification from the user 1818 that includes the set of credentials for the user 1818, it provides the set of credentials to the application simulator access service 1835 for authentication. The application simulator access service 1835 compares the set of credentials against a list of authorized user credentials (e.g., stored in the data store 1833 or in another data store of the application simulator 1831) to determine whether the received set of credentials matches any stored set of credentials. This list of authorized credentials is in some embodiments received from the administrator 1816. The application simulator access service 1835 needs to authenticate the user's credentials (e.g., using security assertion markup language version 2 (SAML2) protocol) before allowing access to the simulated application 1852.

If the application simulator access service 1835 does not authenticate the user 1818, the user 1818 cannot access the simulated application 1852. In some of these embodiments, the user 1818 receives (e.g., through the user's browser) an error notification notifying the user 1818 that they cannot access the simulated application 1852. The process 1900 ends after a failure to authenticate the user (as denoted by the dashed arrowed line).

If the application simulator access service 1835 authenticates the user 1818, the process 1900 presents (at 1940) the simulated application to the user. Once the user 1818 is authenticated and the application simulator access service 1835 notifies the client-side presenter 1853 of the authentication, the client-side presenter 1853 retrieves the simulated display presentations from the data store 1833 and presents them to the user 1818 (e.g., in a browser of the user's UI or GUI).

Each simulated display presentation of the simulated application 1852 is used to create a different HTML display presentation to present to the user 1818. In some of these embodiments, each simulated display presentation has its own client-side presenter in the simulated application 1852, however, one client-side presenter 1853 is illustrated for brevity. The client-side presenter 1853 dynamically creates the HTML display presentations from the simulated display presentations to present the HTML display presentations to the user 1818.

In such embodiments, each simulated display presentation is an empty shell including just <head> and <body> elements. Each simulated display presentation also includes, as data, the painer.js and the HTML structure of the simulated display presentation in JSON format. As each simulated display presentation is retrieved by the client-side presenter 1853, it reads the simulated display presentation's JSON format tree structure and dynamically adds the elements to the DOM, recreating the same structure as in the JSON structure. Each element of the JSON structure includes information regarding the type of element to be created and attributes to be attached to it. If links are to be applied to an element, the SSR 1834 would have specified, in the simulated display presentation, simulation-specific attributes for the JSON element. Based on this, the client-side presenter 1853 attaches an onclick handler to the element to navigate to the linked destination simulated display presentation. In some embodiments, edit and redact transformations of the element are already applied by the SSR 1834 and the JSON structure specifies these changes. In such embodiments, no additional changes are done by the client-side presenter 1853.

In some embodiments, an initial simulated display presentation is presented to the user 1818. This initial simulated display presentation of the simulated application 1852 is displayed as an HTML display presentation and corresponds to the first display presentation of the application 1821 (e.g., a home page). Based on the content of the HTML display presentation, the client-side presenter 1853 in some embodiments issues requests for resources (e.g., images, CSS, or other simulated display presentations, such as iframes). For HTML requests made by the client-side presenter 1853, the access service 1835 responds with the pre-rendered HTML display presentations (i.e., the pre-generated simulated display presentations) based on the simulated application URL the user 1818 input to access the simulated application 1852. For resource requests, uploaded resources are returned. Resources that are included in multiple simulated display presentations of the simulated application 1852 are stored once in the data store 1833 and a unique URL identifies each resource.

In some embodiments, a web application has a malformed HTML DOM structure. However, if the DOM elements of the web application are saved to an HTML display presentation and presented again to the user 1818, the DOM structure is automatically corrected (e.g., by the browser through which the HTML display presentation is presented).

For example, it is not allowed in HTML to have a button inside a button. If the HTML code includes the below structure:
<button⋅name=“button1”>⋅Button⋅1⋅Text⋅<button⋅name=“button2”>⋅Button⋅2⋅Text⋅</button>⋅</button>

and if the above HTML is loaded in a browser, the browser will automatically correct it to the following structure:
<button⋅name=“button1”>⋅Button⋅1⋅Text⋅</button> and
<button⋅name=“button2”>⋅Button 2⋅Text⋅</button>.

However, after an HTML display presentation is presented, and if a JavaScript dynamically adds a button inside a button, the HTML display presentation will be allowed and not automatically corrected. As such, malformed HTML is often created from a JavaScript code. If the application simulator 1831 generates a fully formed HTML code and presents such malformed content to the user 1818, the HTML DOM structure is in some embodiments automatically corrected and changed.

The changed DOM structure also appears differently in some embodiments. For example, the button-side-button appears differently than button-next-to-button. To obviate such issues, a JSON structure is used in some embodiments instead of HTML to present simulated display presentations dynamically using JavaScript.

In some embodiments, only one simulated display presentation is displayed at a time to the user 1818. In other embodiments, at least two simulated display presentations can be displayed at once. As the simulated display presentations are displayed to the user 1818, the user 1818 can interact with them (e.g., by selecting elements corresponding to flow-based controls) to flow through different workflows of the simulated application 1852.

At 1945, the process 1900 provides guided training of the simulated application to the user. When the simulated display presentations are being presented to the user 1818, the DAP and analytics service agent 1841 initiates the DAP guidance and analytics tracker 1860. This provides the training display presentations along with the simulated application's simulated display presentations (e.g., using popup windows) in order to provide guided training of the simulated application 1852 and its flows for the user 1818.

In some embodiments, the JS embed module 1851 of the simulated application 1852 embeds a DAP and analytics overlay from the DAP guidance and analytics tracker 1860 on top of the simulated application 1852. The JS embed module 1851 understands DAP and analytics overlay elements that are to be configured for the user 1818 and loads all the configured overlay widgets (i.e., the training display presentations) onto the simulated display presentations of the simulated application 1852. Self-help and task list widgets are in some embodiments configured to be presented to the user 1818. In such embodiments, the user 1818 has structured learning of the simulated application 1852 based on the guidance of these widgets.

Lastly, the process 1900 collects (at 1950) analytics regarding the user's interaction with the simulated application and the guided training of the simulated application. As the DAP guidance and analytics tracker 1860 and JS embed 1851 provide guided training of the simulated application 1852, the DAP and analytics service agent 1841 in some embodiments collects analytics regarding the user's interaction with the simulated application 1852 and the guided training. In such embodiments, trackers are configured in the simulated application 1852 (e.g., by the JS embed 1851) to track user interaction with the simulated application 1852 and report the user's activities to the DAP and analytics service agent 1841, which stores these reports in the data store 1842. Such reports can include, for example, statistics regarding how many users completed all workflows of the simulated application, which users have completed the workflows, which users have yet to start any workflows, the average time it takes to complete each workflow, which users are taking more time to complete the workflows, etc.

In some embodiments, the DAP and analytics service agent 1841 also provides the analytics to the DAP and analytics module 1825 of the application training program 1822 to present the analytics to the administrator 1816. Such analytics can include, for example, statistics regarding how many users completed all workflows of the simulated application, which users have completed the workflows, which users have yet to start any workflows, the average time it takes to complete each workflow, which users are taking more time to complete the workflows, etc. In such embodiments, the administrator 1816 views the analytics (e.g., in a report presented in a dashboard page of the application training program 1822). Using this information, the administrator 1816 can make informed decisions about training future users, modifying the simulated application 1852, etc.

The above-described embodiments describe methods and systems for simulating an application. This simulated application provides a highly interactive practice environment for the actual application. An application simulation system has simplified creation, deployment, and maintenance capabilities that are targeted towards both onboarding and hands-on training needs. Using this application simulation system (rather than previous solutions to simulate applications) provides significant reduction in training cost due to the lesser cost to acquire, deploy, and maintain the simulated environment. The application simulation system in some embodiments also provides faster onboarding, a realistic simulated environment with DAP guidance executing on top of the simulated application that enables effective and interactive training for users, and an increase in adoption that provides better familiarity with application processes and workflows that results in better adoption and reduced support costs.

The embodiments described throughout this specification refer to a simulated application that provides a realistic replica of an application for training similar to previous solutions that used a sandbox environment or HTML-based simulation tools. However, the above-described simulated application decouples simulated display presentations and structured simulation workflows. If there is a change in the application, only the affected simulated display presentation(s) is to be modified, due to the decoupled approach for the simulated display presentations and workflows. The workflows that include the affected simulated display presentation(s) do not have to be recaptured by the application simulation system, which increases efficiency in maintaining the simulated application.

Additionally, the application simulation system automatically captures display presentations of the application as simulated display presentations and links between these simulated display presentations. This is similar to HTML-based simulation tools. However, because simulated display presentations and flows are decoupled, a single capture of simulated display presentations with their links can be used in multiple workflows, rather than just one.

The above-described embodiments are described in reference to providing simulated operations of a single standalone application. The single standalone application can be a single web-based application. This web-based application can be implemented by an application server accessible through a cluster of one or more web servers. In such embodiments, the web server cluster facilitates access to the application server and the web-based application. The application server can be a part of a cluster of one or more application servers that executes on one or more virtual machines, Pods, or standalone server computers in a datacenter (e.g., private datacenter, public datacenter). The cluster of web servers can also execute on one or more virtual machines, Pods, or standalone server computers in a public or private datacenter.

While the above-described embodiments refer to a simulation that performs simulated operations for one application, a simulation can also simulate operations of a set of two or more applications. In such embodiments, the application simulation system generates a simulation that simulates the set of applications. Each application in the application set can have (1) a different service performed by the application, (2) a different source code for the application, (3) a different application developer that developed the application, and/or (4) a different cluster of one or more application servers that executes the application. Examples of services performed by an application include customer support, banking, communications (e.g., email), stock exchange, streaming, rideshare, food delivery, etc. One application can perform a set of one or more services.

The application set in some embodiments includes two or more web-based applications that are implemented by two or more different clusters of one or more application servers. In such embodiments, the web-based applications can be accessed through a same set of one or more web servers through or different sets of one or more web servers.

At least one of the simulated display presentations of the simulation can be created based on a display presentation of a first application, while also including a flow-based control that transitions to a simulated display presentation created based on a display presentation of a second application. Each simulated display presentation can include (1) one or more flow-based controls that transition to one or more other simulated display presentations of the same application and/or (2) one or more flow-based controls that transition to one or more other simulated display presentations of one or more other applications. Any number of applications can be used when providing simulation operations as described throughout this specification.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

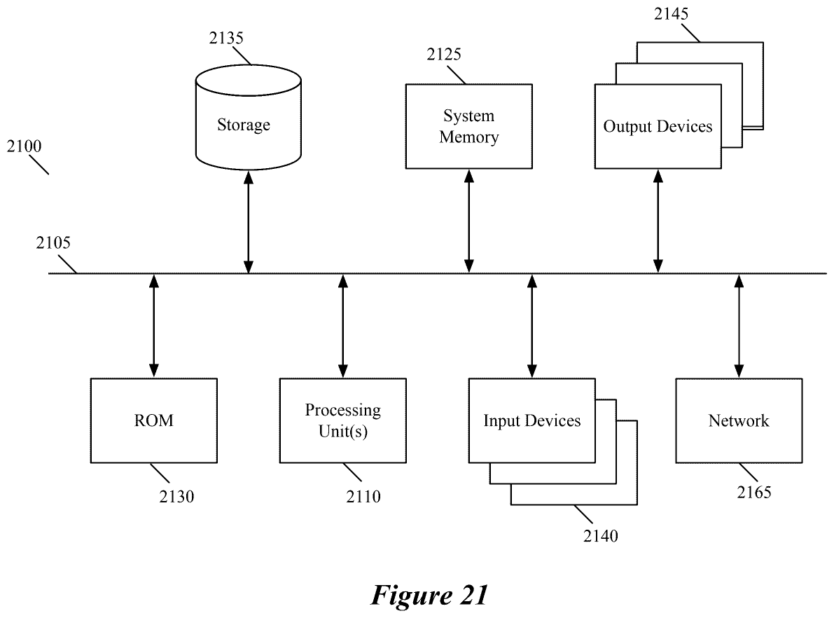

FIG. 21 conceptually illustrates a computer system 2100 with which some embodiments of the invention are implemented. The computer system 2100 can be used to implement any of the above-described computers and servers. As such, it can be used to execute any of the above described processes. This computer system includes various types of non-transitory machine readable media and interfaces for various other types of machine readable media. Computer system 2100 includes a bus 2105, processing unit(s) 2110, a system memory 2125, a read-only memory 2130, a permanent storage device 2135, input devices 2140, and output devices 2145.

The bus 2105 collectively represents all system, peripheral, and chipset buses that communicatively connect the numerous internal devices of the computer system 2100. For instance, the bus 2105 communicatively connects the processing unit(s) 2110 with the read-only memory 2130, the system memory 2125, and the permanent storage device 2135.

From these various memory units, the processing unit(s) 2110 retrieve instructions to execute and data to process in order to execute the processes of the invention. The processing unit(s) may be a single processor or a multi-core processor in different embodiments. The read-only-memory (ROM) 2130 stores static data and instructions that are needed by the processing unit(s) 2110 and other modules of the computer system. The permanent storage device 2135, on the other hand, is a read-and-write memory device. This device is a non-volatile memory unit that stores instructions and data even when the computer system 2100 is off. Some embodiments of the invention use a mass-storage device (such as a magnetic or optical disk and its corresponding disk drive) as the permanent storage device 2135.

Other embodiments use a removable storage device (such as a flash drive, etc.) as the permanent storage device. Like the permanent storage device 2135, the system memory 2125 is a read-and-write memory device. However, unlike storage device 2135, the system memory is a volatile read-and-write memory, such a random access memory. The system memory stores some of the instructions and data that the processor needs at runtime. In some embodiments, the invention's processes are stored in the system memory 2125, the permanent storage device 2135, and/or the read-only memory 2130. From these various memory units, the processing unit(s) 2110 retrieve instructions to execute and data to process in order to execute the processes of some embodiments.

The bus 2105 also connects to the input and output devices 2140 and 2145. The input devices enable the user to communicate information and select commands to the computer system. The input devices 2140 include alphanumeric keyboards and pointing devices (also called “cursor control devices”). The output devices 2145 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 21, bus 2105 also couples computer system 2100 to a network 2165 through a network adapter (not shown). In this manner, the computer can be a part of a network of computers (such as a local area network (“LAN”), a wide area network (“WAN”), or an Intranet, or a network of networks, such as the Internet. Any or all components of computer system 2100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, ctc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for providing simulated operations of an application with a plurality of display presentations through which a plurality of flows is defined, the method comprising:
retrieving non-flow-based content for two or more display presentations from a first storage structure;
retrieving flow-based controls for the two or more display presentations from a second storage structure, wherein each particular flow-based control is associated with at least one particular display presentation and is selectable to direct the application to transition to the particular display presentation, and the non-flow-based content of each display presentation comprises one or more sets of data for display in one or more sections of the display presentation; and
generating each of a plurality of simulated display presentations by combining the flow-based controls and non-flow-based content retrieved from the first and second storage structures.

2. The method of claim 1, wherein the simulated operations are provided for purposes of training a user to use the application, and do not modify data stored in any data store used by the application to provide display presentations during non-simulation operation of the application.

3. The method of claim 2, wherein generating each of the plurality of simulated display presentations comprises pre-rendering the plurality of simulated display presentations before the plurality of simulated display presentations is accessed by the user.

4. The method of claim 2 further comprising generating a set of one or more training display presentations to provide guided training for the user.

5. The method of claim 4, wherein the set of training display presentations comprises a set of popup windows that is displayed along with the plurality of simulated display presentations to guide the user through the plurality of flows in the plurality of simulated display presentations.

6. The method of claim 1, wherein the application comprises a web application accessible through a browser, and the web application provides the display presentations through a plurality of display areas presented by the browser.

7. The method of claim 6, wherein the plurality of display presentations of the web application can be accessed to perform non-simulation operation of the web application using a first uniform resource locator (URL), and the plurality of simulated display presentations can be accessed to perform the simulated operations using a second URL.

8. The method of claim 1, wherein the flow-based controls comprises at least one flow-based control that is part of at least two display presentations but is only stored once in the second storage structure.

9. The method of claim 1, wherein:
retrieving the non-flow-based content comprises retrieving two or more code copies collected for the two or more display presentations, and
generating each of the plurality of simulated display presentations comprises generating each of the plurality of simulated display presentations by combining the two or more code copies and the flow-based controls.

10. The method of claim 9, wherein the two or more code copies specify (i) an identifier (ID) for each flow-based control and (ii) the non-flow-based content.

11. The method of claim 10, wherein at least two code copies specify a particular ID that identifies a particular flow-based control such that the particular flow-based control is part of at least two simulated display presentations.

12. The method of claim 9, wherein the two or more code copies are two or more Hypertext Markup Language (HTML) code copies.

13. The method of claim 1, wherein the non-flow-based content and the flow-based controls are custom defined for the application by one or more application developers of the application, the application further comprising a common set of content defined by a platform developer that developed a platform on which the application operates, the platform comprising at least one of an operating system or a browser on which the application operates.

14. The method of claim 1 further comprising presenting the plurality of simulated display presentations to a user in a set of one or more display areas of a user interface (UI).

15. The method of claim 14, wherein the simulated display presentations of the plurality of simulated display presentations are presented successively such that one simulated display presentation is presented at a time.

16. The method of claim 14, wherein at least two simulated display presentations are presented concurrently to the user.

17. The method of claim 14, wherein presenting the plurality of simulated display presentations comprises:
presenting a first simulated display presentation to the user in the set of display areas; and
after determining that the user selected a flow-based control in the set of flow-based controls, presenting a second simulated display presentation to the user in the set of display areas.

18. The method of claim 17, wherein presenting the second simulated display presentation to the user in the set of display areas comprises:
examining the second data structure to match the selected flow-based control to the second simulated display presentation as a destination simulated display presentation upon selection of the selected flow-based control; and
replacing the first simulated display presentation in the set of display areas with the second simulated display presentation.

19. The method of claim 1, wherein each of the plurality of flows comprises a different sequence of one or more flow-based controls that defines a different order of at least a subset of display presentations.

20. The method of claim 1, wherein the application is a single standalone application.

21. The method of claim 20, wherein the single standalone application is a standalone web-based application implemented by a cluster of one or more application servers accessible through a cluster of a set of one or more web servers.

22. The method of claim 1, wherein the retrieving and generating are performed to provide simulated operations of a set of two or more applications, wherein each application has at least one of (i) a different service performed by the application, (ii) a different source code for the application, (iii) a different application developer that developed the application, and (iv) a different cluster of one or more application servers that executes the application.
